(19) United States
(12) Patent Application Publication
(10) Pub. No.: US 2026/0226238 A1
(43) Pub. Date: Aug. 6, 2026

(54) Polymer Networks and Composites of Tunable Structures and Methods of Their Production

(71) Applicant: The Regents of the University of California, Oakland, CA (US)

(72) Inventors: Ximin He, Los Angeles, CA (US); Yousif Alsaid, Los Angeles, CA (US); Yichen Yan, Los Angeles, CA (US)

(73) Assignee: The Regents of the University of California, Oakland, CA (US)

(21) Appl. No.: 19/150,501

(22) PCT Filed: Jan. 25, 2024
(86) PCT No.: PCT/US2024/013006

§ 371 Date: Jul. 23, 2025

Related U.S. Application Data
(60) Provisional application No. 63/481,975, filed on Jan. 27, 2023.

(51) Int. Cl. C08J 3/075; H01M 4/38; H01M 4/60

(52) U.S. Cl. CPC C08J 3/075; H01M 4/38; H01M 4/606; C08J 2329/04; H01M 2300/0085

(57) ABSTRACT

Systems and methods for producing structured hydrogel electrolytes with interconnected pores are described. The methods implement the cononsolvency effect and the salting, out effect. The hydrogel electrolytes have enhanced mass transport and mechanical properties, and anti-freezing properties, suitable for applications in harsh conditions.

### CROSS-REFERENCE TO RELATED APPLICATIONS

The current application claims the benefit of U.S. Provisional Patent Application No. 63/481,975 entitled “Polymer Networks and Composites of Tunable Structures and Methods of Their Production” filed Jan. 27, 2023. The disclosure of U.S. Provisional Patent Application Nos. 63/481,975 is hereby incorporated by reference in its entirety for all purposes.

### FIELD OF THE INVENTION

The present invention generally relates to micro- and nano-structured gels, polymers and/or composite materials with tunable properties via the synergy of cononsolvency and Hofmeister (or specific ion) effects, and methods of their fabricating.

### BACKGROUND OF THE INVENTION

Structured porous materials can be used in applications including catalysis, tissue engineering, separations, optics, energy, molecule carriers, drug delivery, water desalination, oil separation and life science. Several methods have been proposed to produce hierarchical structures, for example, templating, adding macro/nano materials, and layer-by-layer. However, such methods suffer from drawbacks like complex procedures, expensive raw materials, small-scale fabrication, and non-tunable structures. Improved methods of fabricating hierarchically porous materials may be needed to address these issues.

### BRIEF SUMMARY OF THE INVENTION

Many embodiments are directed to methods of fabricating micro and nano structured hydrogels with tunable properties via the synergistic combination of interactions between ions-monomers/polymers (Hofmeister) and solvents-monomers/polymers (cononsolvency), with tunable interaction between the ions, solvents, and monomers/polymers.

Some embodiments include a method of fabricating a hydrogel comprising: mixing a solute, a solvent, and a cosolvent to form a hydrogel via a cononsolvency effect, wherein the solute dissolves in the solvent and the cosolvent, wherein the solvent and the cosolvent are miscible and have different polarity; and solidifying the hydrogel in a salt solution, wherein the salt solution induces a formation of a plurality of hydrogen bonds in the hydrogel such that the hydrogel toughens.

In some embodiments, the cosolvent has a stronger interaction with the solute than the solvent.

Some embodiments further comprise heating and stirring the mixed solute, solvent, and cosolvent to form a homogeneous solution before forming a hydrogel.

Some embodiments further comprise forming the hydrogel in a mold to achieve a desired shape.

In some embodiments, the hydrogel is formed in a freezer.

In some embodiments, the solute is a polymer selected from the group consisting of poly(n-isopropyl acrylamide) (PNIPAM), poly(vinyl alcohol) (PVA), polyacrylamide (PAM), and poly(N-tert-butyl acrylamide)-co-polyacrylamide (PNTBAM-co-PAM).

In some embodiments, the solute is PVA, the solvent is dimethyl sulfoxide (DMSO), the cosolvent is water, and the salt solution comprises zinc sulfate.

In some embodiments, the toughened hydrogel has a tensile strength of at least 1.5 MPa, a toughness of at least 4.5 MJ/m³, and an ionic conductivity of at least 4.7 mS/cm at −20° C.

In some embodiments, the toughened hydrogel is anti-freezing at a temperature lower than or equal to −20° C. and is configured to be a portion of a zinc ion battery.

In some embodiments, the zinc ion battery is a zinc polyaniline battery, and the battery is dendrite-free after at least 3000 cycles from 25° C. to −20° C.

In some embodiments, the solute is selected from the group consisting of PNIPAM, PVA and PNTBAM-co-PAM, the solvent is DMSO, the cosolvent is water, and the salt solution comprises potassium acetate and zinc acetate.

In some embodiments, the toughened hydrogel has a tensile strength of at least 15 MPa, a toughness of at least 84 MJ/m³, a Young's modulus of at least 8 MPa, and an ionic conductivity of at least 50 mS/cm at 20° C.

In some embodiments, the toughened hydrogel is anti-freezing at a temperature lower than or equal to −80° C. and is configured to be a portion of a zinc ion battery.

In some embodiments, the zinc ion battery is a zinc polyaniline battery, the battery is dendrite-free after at least 30,000 cycles from 25° C. to −20° C., and the battery has a reversible capacity of 50 mA h g⁻¹ after 1,000 cycles at 25° C., and a reversible capacity of 57 mA h g⁻¹ after 30,000 cycles at −20° C.

Some embodiments include a method of fabricating a zinc ion battery comprising: forming a cathode and an anode for a zinc ion battery; and forming a hydrogel electrolyte positioned in between the cathode and the anode, wherein the hydrogel electrolyte is formed via a process comprising: mixing a solute, a solvent, and a cosolvent to form a hydrogel via a cononsolvency effect, wherein the solute dissolves in the solvent and the cosolvent, wherein the solvent and the cosolvent are miscible and have different polarity; and solidifying the hydrogel in a salt solution, wherein the salt solution induces a formation of a plurality of hydrogen bonds in the hydrogel such that the hydrogel toughens.

In some embodiments, the cosolvent has a stronger interaction with the solute than the solvent.

Some embodiments further comprise heating and stirring the mixed solute, solvent, and cosolvent to form a homogeneous solution before forming a hydrogel.

Some embodiments further comprise forming the hydrogel in a mold to achieve a desired shape.

In some embodiments, the hydrogel is formed in a freezer.

In some embodiments, the solute is a polymer selected from the group consisting of poly(n-isopropyl acrylamide) (PNIPAM), poly(vinyl alcohol) (PVA), polyacrylamide (PAM), and poly(N-tert-butyl acrylamide)-co-polyacrylamide (PNTBAM-co-PAM).

In some embodiments, the solute is PVA, the solvent is dimethyl sulfoxide (DMSO), the cosolvent is water, and the salt solution comprises zinc sulfate.

In some embodiments, the toughened hydrogel has a tensile strength of at least 1.5 MPa, a toughness of at least 4.5 MJ/m³, and an ionic conductivity of at least 4.7 mS/cm at −20° C.

In some embodiments, the toughened hydrogel is anti-freezing at a temperature lower than or equal to −20° C.

In some embodiments, the battery is a zinc polyaniline battery, and the battery is dendrite-free after at least 3000 cycles from 25° C. to −20° C.

In some embodiments, the solute is selected from the group consisting of PNIPAM, PVA and PNTBAM-co-PAM, the solvent is DMSO, the cosolvent is water, and the salt solution comprises potassium acetate and zinc acetate.

In some embodiments, the toughened hydrogel has a tensile strength of at least 15 MPa, a toughness of at least 84 MJ/m³, a Young's modulus of at least 8 MPa, and an ionic conductivity of at least 50 mS/cm at 20° C.

In some embodiments, the toughened hydrogel is anti-freezing at a temperature lower than or equal to −80° C.

In some embodiments, the battery is a zinc polyaniline battery, and the battery is dendrite-free after at least 30,000 cycles from 25° C. to −20° C., and the battery has a reversible capacity of 50 mA h g⁻¹ after 1,000 cycles at 25° C., and a reversible capacity of 57 mA h g⁻¹ after 30,000 cycles at −20° C.

Additional embodiments and features are set forth in part in the description that follows, and in part will become apparent to those skilled in the art upon examination of the specification or may be learned by the practice of the disclosure. A further understanding of the nature and advantages of the present disclosure may be realized by reference to the remaining portions of the specification and the drawings, which forms a part of this disclosure.

### BRIEF DESCRIPTION OF THE DRAWINGS

The description will be more fully understood with reference to the following figures, which are presented as exemplary embodiments of the invention and should not be construed as a complete recitation of the scope of the invention, wherein:

FIG. 1A illustrates a fabrication process of the PVA hydrogel electrolyte in accordance with an embodiment.

FIG. 1B illustrates the hydrogen bond interaction between the PVA polymer chains in accordance with an embodiment.

FIG. 1C illustrates the interaction among ions and polymer chains in accordance with an embodiment.

FIGS. 1D and 1E illustrate flexibility of the hydrogel electrolyte in accordance with an embodiment.

FIGS. 2A-2D illustrate the ionic conductivities of the hydrogel electrolytes in accordance with an embodiment.

FIGS. 3A-3C illustrate mechanical properties of the electrolyte hydrogels in accordance with an embodiment.

FIG. 4 illustrates SEM images of the hydrogel electrolytes in accordance with an embodiment.

FIG. 5 illustrates the mechanical property of the PVA hydrogel electrolytes in accordance with an embodiment.

FIGS. 6A and 6B illustrate the compressive and tensile stress-strain curves of PVA-X₃₀ at various temperatures in accordance with an embodiment.

FIG. 6C illustrates the DSC curves of PVA-X₃₀ and PVA-X₆₀ in accordance with an embodiment.

FIGS. 7A and 7B illustrate Raman spectra of the pure DMSO and PVA hydrogel electrolytes in accordance with an embodiment.

FIG. 8A illustrates the voltage profiles of the Zn/Zn symmetric batteries in accordance with an embodiment.

FIG. 8B illustrates Surfaces SEM images of the Zn foils in Zn/Zn batteries after 50 cycles in accordance with an embodiment.

FIG. 8C illustrates surfaces SEM images of the Zn foils in Zn/Zn batteries after 200 cycles in accordance with an embodiment.

FIG. 8D illustrates XRD patterns of the Zn foils in Zn/Zn batteries after 50 cycles in accordance with an embodiment.

FIGS. 9A and 9B illustrate the voltage profiles of the Zn/Zn symmetric batteries in accordance with an embodiment.

FIG. 10 illustrates SEM images of the carbon cloth and the carbon cloth with PANi in accordance with an embodiment.

FIGS. 11A-11H illustrate rate performances, cycle performances, and SEM images of the Zn/polyaniline batteries with PVA-X30 in accordance with an embodiment.

FIG. 12A illustrates a schematic of the soft-pack Zn/PANi battery with PVA-X30 in accordance with an embodiment.

FIG. 12B illustrates the CV curves of the battery at 1 mV/s at 25° C. in accordance with an embodiment.

FIG. 12C illustrates specific capacity during the bending test of the Zn/PANi battery with PVA-X₃₀ at 0.5 A/g and −20° C. in accordance with an embodiment.

FIG. 12D illustrates the stress-strain curves of PVA-X30 made with PVAs of different molecular weights in accordance with an embodiment.

FIG. 13A illustrates a schematic of fabricating a hydrogel electrolyte with a dual salt solution in accordance with an embodiment.

FIG. 13B illustrates flexibility of the hydrogel electrolyte in accordance with an embodiment.

FIGS. 14A and 14B illustrate the Hofmeister effect of the salt solutions in accordance with an embodiment.

FIGS. 15A and 15B illustrate characterization of KAc/ZnAc₂ solution in accordance with an embodiment.

FIG. 16 illustrates voltage profiles of Zn—Cu half cells with aqueous KAc/ZnAc₂ solutions as electrolyte in room temperature in accordance with an embodiment.

FIG. 17 illustrates voltage profiles of Zn—Cu half cells with aqueous KAc/ZnAc₂ solutions as electrolyte at −40° C. in accordance with an embodiment.

FIGS. 18A-18C illustrate tensile test results of 10% wt PVA hydrogels made with various molecular weights and DMSO to water ratios without aging in accordance with an embodiment.

FIGS. 19A-19C illustrate tensile test results of 10% wt PVA hydrogels made with various molecular weights and 6:4 DMSO to water ratios with 0-7 days of aging in accordance with an embodiment.

FIGS. 20A-20C illustrate tensile test results of 15% wt Mw 195 k PVA hydrogels made with various molecular weights and 6:4 DMSO to water ratios with 0-7 days of aging in accordance with an embodiment.

FIGS. 21A-21K illustrate synergistic effects of Hofmeister “salting-out” and cononsolvency in accordance with an embodiment.

FIGS. 22A and 22B illustrate transference number characterization of PVA-416 in accordance with an embodiment.

FIGS. 23A-23D illustrate ionic conductivity measurements of the PVA-416 hydrogel electrolyte at various temperatures in accordance with an embodiment.

FIG. 24 illustrates DSC curves of the PVA-416 hydrogel electrolyte in accordance with an embodiment.

FIGS. 25A-25C illustrate results from the tensile tests, compression tests, and puncture force tests of the PVA-416 electrolyte and the glass fiber separator in accordance with an embodiment.

FIG. 25D illustrates a schematic of a puncture test setup in accordance with an embodiment.

FIGS. 26A and 26B illustrate calendar aging tests in accordance with an embodiment.

FIGS. 27A-27I illustrate electrochemical performance of the Zn-PVA-416-PANi batteries at about 25, −20, and −30° C. in accordance with an embodiment.

FIGS. 28A-28D illustrate electrochemical performance of the Zn-PVA-416-PANi batteries at −40 and −45° C. in accordance with an embodiment.

FIG. 29 illustrates a schematic of the soft-pack battery in accordance with an embodiment.

FIGS. 30A-30B illustrate characterizations of the PNIPAAm hydrogels in accordance with an embodiment.

FIGS. 31A-31C illustrate characterizations of the P(NTBAAm-co-AAm) hydrogels in accordance with an embodiment.

FIGS. 32A-32E illustrate electrochemical characterization of the Zn-PVA-446-PANi batteries in accordance with an embodiment.

### DETAILED DESCRIPTION OF THE INVENTION

Embodiments are directed to a synthesis platform for generating micro and nano structured gel, polymer, and composite materials with ultra-wide range tunability of porous structures and tunable and superior diffusive and mechanical properties by utilizing synergistic ternary ion-solvent-polymer interactions.

Various embodiments incorporate processing steps utilizing specific mixed solvents and ions to create highly interconnected low-tortuosity pore structures and to densify and toughen the polymer framework, through the interaction competitions between the ions, solvents, and monomers/polymers. The possible interactions according to many embodiments include (1) ion-monomer/polymer, (2) solvent-monomer/polymer, (3) cosolvent-monomer/polymer, (4) ion-solvent, (5) ion-cosolvent, and (6) solvent-cosolvent interactions.

In embodiments of such processes, the competitions between these interactions result in monomer and/or polymer aggregation and modulated polymer chain conformations, and consequently modulated porous structures and properties of the resulting polymer networks. The size, charge density, polarity, hydrophobicity, steric factors and relevant properties of the ions, solvents and monomers/polymers affect the above interactions and resulting structures and properties of the polymer networks.

In many of these embodiments, the polymer network formation may start from small molecules (monomers) through polymerization and crosslinking or through oligomers and polymers through crosslinking, in presence of single, mixed solvent, and/or ions, in different possible sequential orders or concurrently. The uses of mixed solvents and ions within embodiments can be in sequence of different orders or concurrently during the polymer network syntheses and treatment processes.

Broad choices of solvents and ions can be used according to embodiments to modulate the polymer aggregation to different extents in different morphologies, i.e., densify and toughen, or loosen and weaken the polymer framework, to endow broad tunability of hierarchical multi-length-scale porous structures and the properties, including mechanical, diffusive, ionic and electron conductive properties.

Ion/solvent concentration gradient, temperature gradient, and other relevant gradients can be used according to embodiments to fabricate a material with controlled gradient porosity and/or mechanical behavior.

In various embodiments these processes may be followed by incorporation of additives such as salt solutions, polymers, surfactants, and ceramics to obtain tough and highly conductive porous gel, polymer, and composite structures with multi-functional and tailorable chemistries for a broad range of metal-ion or metal-electrode batteries, filtration, functional fabric membranes (such as GORE-TEX®), fuel cells, reservoir for flow battery, and other energy storage devices.

The merits of the disclosed technique in accordance with embodiments are: 1) Ultrafast ion transport, observed via ion conductivity measurements (electrochemical impedance spectroscopy, EIS) and cycling tests (galvanostatic charge discharge, GCD), reaching one order of magnitude lower overpotential in battery prototypes when passing the same current. 2) High mechanical properties spanning 6 orders of magnitude, for example a high tensile strength from at least 1.5 MPa to a low tensile strength similar to brain tissue. 3) Scalable, facile, room-temperature, and inexpensive solution-based synthesis enabling rapid and large-scale manufacture of tough highly conductive gel, polymer, and composite electrolytes. Solution based synthesis enable multiple synthesis processes: spin coating, doctor blading, molding, etc. 4) Wide range of applications attributed to the versatile and broad choice of polymers, ions, solvents, surfactants, and ceramic additives. For example, enabling lithium metal batteries with 40% higher energy density than conventional Li-ion batteries with carbon anodes, due to suppressed dendrite growth (which harms the battery reliability), high ionic conductivity and high electrochemical stability, to mitigate the dendrite issue, polymer toughening method listed in this disclosed invention can be applied to a composite electrolyte to achieve high toughness, which suppressed dendrite growth.

The disclosed embodiments comprise techniques for producing tough and highly ionically conductive micro- and nano-porous gel, polymer, and composite structures utilizing ternary ion-solvent-polymer interactions. Exemplary polymer systems where both can be found are poly N-isopropylacrylamide (PNIPAM) and polyvinyl alcohol (PVA), however since such interactions are generic, this can encompass a broad range of candidate polymer frameworks. The polymer can be cross-linked into a tough and low-tortuosity framework, either from linear chain segments via physical interactions or from monomers or linear chains via covalent interactions, as is the case in PVA, or from monomer solutions cross-linked in-situ, as seen in PNIPAM. While ion interactions can be observed in nearly all polymer systems, solvent-ion-polymer interactions can be more selective according to the following solvent, ion, and monomer/polymer selection criteria: 1) The pure solvent and pure cosolvent must both have strong interactions with the polymer, and act as good solvents individually. 2) The solvent and cosolvent may or may not be miscible, as both direct mixing or solvent replacement can be used. 3) Between the solvent and cosolvent, one need to have stronger interactions with the polymer than the other, i.e., one is a better solvent for the polymer than the other, to yield lowered solubility of the polymer in the mixed solvent. 4) The ions used should be chosen specifically to induce desired level of aggregation of the monomers or polymers. Typically, for hydrophilic molecules and water solvent, kosmotropic ions, show strong salting out effect, and will lead to higher mechanical properties; chaotropic ions, on the contrary, show weak salting out effect (or salting in effect), will lead to lower mechanical properties, all governed by the Hofmeister effect. 5) The polymer network formation may start from small molecules (monomers) through polymerization and crosslinking or through oligomers and polymers through crosslinking, in presence of single, mixed solvent, and/or ions, in different possible sequential orders or concurrently. 6) The selection of ions, solvents, cosolvents, and monomer/polymers may consider the size, charge density, polarity, hydrophobicity or hydrophilicity, steric factors and all the factors that affect their interactions. 7) The selection of ions and solvents may consider the synergy of the ion-solvent-polymer interactions or may be selected independently, depending on the procedure and applications of ions and solvents. For example, as for ion solubility, if concurrent, i.e., solvent, cosolvent and ions are in present in the monomer/polymer solution, they need to be mutually miscible or the ions need to be soluble in the solvent and/or cosolvent; otherwise, ions may not be soluble in the cosolvent. Overall, the effects of different solvents and ions on the monomers and polymers determine and modulate the porous structures and properties of the resulting polymer networks.

In summary, according to various embodiments, tough highly-ionically-conductive porous polymers are synthesized via sequential ion and solvent treatment steps. By rational selection of anions and cations, introduced via dissolution of salts into the polymer solution or crosslinked polymer scaffold, one can promote differing conformations of the polymer chains; kosmotropic salts promote densification of the polymer chains, resulting in improved mechanical properties and extremely high toughness. Solvent treatment aims to improve the diffusive properties of the in-situ polymerized or pre-formed polymer by promoting mixed solvent-induced phase separation, as well as to improve or maintain the mechanical properties of the polymer. The two steps can happen sequentially or concurrently. This working principle for creating highly ionically conductive and tough electrolytes can be theoretically applied to unlimited polymers, since all polymer exhibiting interactions with both solvents and ions.

According to some embodiments tough highly-ionically-conductive porous structures are synthesized via sequential or concurrent ion and solvent treatments as an example of this disclosed invention. The polymers according to these embodiments will be made into monolith with ultrafast molecular transport by phase separation from specific mixed solvents treatment such as methanol and water or dimethylsulfoxide and water, and then will be strongly densified or weaken by kosmotropic or chaotropic salts such as sodium citrate, sodium sulfate, potassium acetate, and zinc sulfate. In some embodiment, a strengthened polymer monolith will have a Young's moduli nearly 20 MPa and Tensile strength higher than the elastomer materials for smartwatch wristbands. The ultrafast molecular transport can be seen in the high room temperature ionic conductivities, around 50 mS/cm, depend on the ion types and concentration. According to other embodiments composite materials can be made by blending in ceramic particles, quantum dots, 2D materials, polymer, and surfactant additives, etc., in any of these steps to endow additional functionalities to the porous material. For example, in various embodiments quantum dots which can attract anions can be added to enhance the transference number of the polymer electrolyte.

The cononsolvency effect is when a solute is highly soluble in two or more individual solvents, but insoluble in a mixture of them. Two or more solvents may compete to adsorb onto hydrophilic and hydrophobic sites of the solute, and the system may preferentially favor complete adsorption of one solvent over another in accordance with some embodiments. In mixed solvent conditions, one solvent preferentially may adsorb onto the solute surface, ejecting the other solvent, resulting in the self-aggregation of the solute in accordance with certain embodiments.

Turning now to the drawings and data, template-free synthesis methods for generating hierarchical porous polymer materials with tunable properties and behaviors via the synergistic combination of the cononsolvency and Hofmeister effect are described. Many embodiments provide tunable techniques involving the dissolution of a solute in a mixture of at least two solvents with different polarities. Upon solidification, if the solute experiences cononsolvency in the presence of the mixed solvents, it can experience local self-collapse forming a hierarchical porous network with enhanced diffusion and mechanical properties in accordance with several embodiments, compared to conventional materials not utilizing the cononsolvency effect. The solidified polymers (such as, but not limited to, hydrogels) can be soaked in salt solutions to induce the Hofmeister salting-out effect. The porous polymers can have fast and tunable molecular transport, and the transport rates (such as, but not limited to, water transport rates) can be tuned by varying solvent and solute concentrations, and/or salt solutions. A number of embodiments show porous materials with enhanced and tunable mechanical properties including (but not limited to): compressive toughness and Young's modulus. Such properties can also be tuned by varying solvent and solute concentrations, and/or salt solutions in accordance with some embodiments. In many embodiments, scalable, facile, and inexpensive solution-based synthesis methods combining cononsolvency and Hofmeister effect enable rapid and large-scale manufacture of template-free hierarchical porous materials with tunable pore morphology and molecular transport. In several embodiments, the synthesis methods can apply to a versatile and broad choice of solutes, solvents, and solidification processes which can exhibit cononsolvency effect and Hofmeister effect.

Many embodiments provide methods for producing hierarchically structured networks of materials. In several embodiments, the methods include 1) at least a solute including (but not limited to): monomer molecules or polymer chains, 2) a mechanism for solidification/networking (for example, photopolymerization), 3) a mixture of at least two mutually soluble solvents that show cononsolvency in the presence of the desired solidified solute, 4) a desirable salt solution to induce the Hofmeister salting-out effect. The rational control of the cononsolvency effect and Hofmeister effect in accordance with several embodiments can enable pore structure tuning and can facilitate physical cross-linking. Many embodiments may exhibit hierarchical structures when: 1). the pure solvent and pure cosolvent are both able to fully dissolve the solidified solute; 2). the solvent and cosolvent are mutually miscible; 3). the cosolvent behaves as a stronger solvent than the solvent, for example, one should have a stronger interaction with the polymer than the other; and 4). the solute is fully soluble in the mixed solvent before solidification.

To synthesize hierarchically structured materials, many embodiments provide that the solute initially should not exhibit cononsolvency, remaining soluble even in the mixture of the solvents. Several embodiments show that if the solute gains cononsolvency behavior during solidification, it can experience cononsolvency-induced self-aggregation resulting in hierarchical open-celled pore networks. In a number of embodiments, the morphology can be tunable based on the extent of this self-aggregation, which can be tuned via changing the polarities of the solutes and solvents, as well as their molar ratios. This working principle of creating hierarchically porous structures in accordance with embodiments can be applied to polymers including (but not limited to): poly(n-isopropyl acrylamide) (PNIPAM), poly(vinyl alcohol) (PVA), polyacrylamide (PAM), and poly(N-tert-butyl acrylamide)-co-polyacrylamide (PNTBAM-co-PAM).

Many embodiments provide that porous hydrogels have cononsolvency-induced physical crosslinking and gelation functions. Several embodiments apply porous hydrogel synthesis methods in making hierarchical PVA hydrogels. Polymers with a hydrophobic backbone and hydrophilic functional group, copolymers composed of hydrophobic and hydrophilic segments, or polymers with segments of different wettability can form gels, or gelate, induced by cononsolvency effect in accordance with several embodiments. In some embodiments, PVA can form a hydrogel in a mixture of water and dimethyl sulfoxide (DMSO) via the cononsolvency effect. The gelation can be induced by polymer chain collapse and physical crosslinking, promoted by the strong interaction between water and DMSO molecules. Many embodiments provide that the cononsolvency-enabled gelation may work with any polymers that can form strong bonding including (but not limited to): H-bonding, hydrophobic interactions, and π-π interaction to physically crosslink themselves.

Several embodiments provide that the porous hydrogels have cononsolvency-induced anti-freezing properties. In some embodiments, the synthesis methods can be applied to anti-freezing hierarchical PVA hydrogels. The strong interaction between water and DMSO molecules make the water/DMSO binary system have lower freezing temperature than the pure solvents do in accordance with certain embodiments.

Some embodiments utilize PVA of various molecular weights (ranging from about 80 kDa to about 200 kDa) as the polymer backbone for making the hydrogel electrolyte. The PVA polymer backbone can be mixed with a liquid component comprising zinc sulfate (ZnSO₄), dimethyl sulfoxide (DMSO), and water. DMSO and water act as the cosolvent and solvent. Upon polymerization into PVA, cononsolvency behavior can be observed in the presence of DMSO and water. Zinc sulfate provides mobile ions and toughens the hydrogel, while DMSO lowers the freezing temperature, suppresses dendrite growth, and benefits the hydrogel morphology. By tuning the DMSO mole fraction in the solvent mixture, different diffusion and mechanical properties can be achieved in accordance with several embodiments. The hydrogel electrolyte in accordance with various embodiments can achieve a tensile strength of at least about 1.5 MPa; or at least about 2 MPa; or at least about 5 MPa; and a toughness of at least about 4.5 MJ/m³, or at least about 5 MJ/m³. The hydrogel electrolyte can achieve an ionic conductivity of at least about 4 mS/cm; or at least about 4.5 mS/cm; or at least about 5 mS/cm, at about −20° C. or lower. The hydrogel electrolyte can suppress dendrite growth. The hydrogel electrolyte can be integrated in zinc ion batteries such as zinc polyaniline cells and enable stable and reversible battery operation. The cell can stay dendrite-free after at least 1000 cycles; or at least 2000 cycles; or at least 3000 cycles; from about 25° C. to about −20° C.

Several embodiments implement dual salt solutions to fabricate the hydrogel electrolyte. Polymers such as PVA, PNIPAM, and/or PNTBAM-co-PAM can be used as the polymer backbones. Water and DMSO can be used as solvent and cosolvent. In some embodiments, a polymer/water solution and a polymer/DMSO solution can be prepared. The two solutions can be mixed to induce cononsolvency to form a hydrogel. The hydrogel can then be soaked in a salt solution to induce the Hofmeister salting-out effect. A salt mixture such as (but not limited to) potassium acetate (KAc), and zinc acetate (ZnAc₂) can be used for the salt solution. The salt ions can disrupt the hydrogen bond networks to toughen the hydrogels. The potassium acetate can render the anti-freezing abilities to the hydrogel electrolyte. The hydrogel electrolyte can achieve a tensile strength of at least about 15 MPa; or at least about 20 MPa. The hydrogel electrolyte can have a freeze-tolerance of lower than or equal to about −70° C.; or lower than or equal to about −77° C. The hydrogel electrolyte can have a mass transport of about 10 times lower overpotential compared to the less porous counterparts. The hydrogel electrolyte can be integrated into zinc ion batteries such as (but not limited to) zinc polyaniline batteries. The batteries have dendrite and parasitic reactions suppression for stable performance of at least about 30,000 cycles.

Hydrogel Electrolytes with Anti-Freezing and Dendrite-Suppressing Properties

Many embodiments provide anti-freezing, dendrite-suppressing, and tough hydrogel electrolytes. The hydrogel electrolytes can be made with low-cost ingredients such as polyvinyl alcohol, zinc sulfate, dimethyl sulfoxide, and water. Zinc sulfate provides mobile ions and toughens the hydrogel, while dimethyl sulfoxide lowers the freezing temperature, suppresses dendrite growth, and benefits the hydrogel morphology. Some embodiments utilize the anti-freezing effect, dendrite suppression ability, and morphology tuning ability of DMSO as well as the strengthening effect of ZnSO₄. The hydrogel electrolytes in accordance with some embodiments show mechanical properties including a tensile strength of at least about 1.585 MPa and a toughness of at least about 4.5 MJ/m³. The hydrogel electrolyte can have a high ionic conductivity of at least about 4.743 mS/cm at about −20° C. and dendrite-suppressing performance. The hydrogel electrolyte can enable stable and reversible battery operation in a Zn/PANi cell. The cell is dendrite-free after thousands of cycles at 25° C. and −20° C. The soft-pack batteries made with PVA-X₃₀ show durability and stability due to the robustness of the hydrogel.

Lithium-ion batteries have high energy density and long lifespan, but have drawback such as high cost, flammability, and toxicity, which may limit their potential as grid storage or wearable electronics. Aqueous zinc-ion batteries (AZIBs) may be beneficial as power sources due to their safety, low cost, resource abundance, and high theoretical capacity. Nevertheless, AZIBs using traditional liquid electrolytes still suffer from issues including leakage, dendrite growth, hydrogen evolution, byproduct formation, and cathode dissolution. Hydrogel electrolytes with crosslinked polymer network swollen with aqueous solution may be able to mitigate these problems through the polymer-ion-water interactions as well as enhanced mechanical properties compared to their liquid counterparts, which allow them to endure large mechanical deformation while still effectively separating the cathode and anode to prevent shorting. For real-life applications, it is also beneficial for the electrolytes to exhibit anti-freezing behavior to inherently adapt to low-temperature environments, without needing bulky and costly engineering designs to heat the batteries.

Utilizing highly-concentrated salts is one of the main strategies for anti-freezing hydrogel electrolytes. However, the high cost of the salts, (e.g., bis(trifluoromethane sulfonyl)imide and trifluoromethanesulfonate salts) as well as the low conductivities and high viscosities may limit this approach. (Y. Zhao et al., Adv. Sci., vol. 8, no. 1, pp. 1-13, 2021; the disclosure of which is incorporated by reference.) Adding organic additives can be another strategy for anti-freezing hydrogel electrolytes. However, the resulting hydrogels may have insufficient robustness (e.g., 120 kPa ultimate tensile strength), which makes the hydrogel electrolyte susceptible to impact damage that can lead to battery shorting. (M. Chen et al., J. Mater. Chem. A, vol. 8, no. 14, pp. 6828-6841, 2020; the disclosure of which is incorporated by reference.) Therefore, hydrogel electrolytes that can be made with low-cost ingredients, and have desired mechanical properties at both ambient and subzero temperatures are needed.

Many embodiments provide anti-freezing, dendrite suppressing, and mechanically strong hydrogel electrolytes that are made with low-cost chemicals. In several embodiments, the hydrogel electrolytes can be made with low-cost chemicals such as (but not limited to) polyvinyl alcohol (PVA) as the polymer backbone and zinc sulfate (ZnSO₄)/dimethyl sulfoxide (DMSO)/H₂O as the liquid component. The addition of DMSO to water can benefit the freezing tolerance of the system and suppress the dendrite formation through regulated zinc-ion deposition, and also induce mass-transport-benefiting morphology in PVA through cononsolvency effect, where the aggregation of polymer chains happens in the mixtures of two appropriate solvents. The ZnSO₄ salt provides the mobile ions for a zinc-ion battery electrolyte, and enhances the robustness of the PVA hydrogel due to Hofmeister “salting-out” effect, where ions enhance polymer chain aggregation. The ultimate tensile strength (UTS) and toughness of the hydrogel electrolyte can reach at least 5 times and 50 times higher than those of the commercial glass fiber separator, respectively. The Zn/PANi batteries assembled with the anti-freezing, dendrite suppressing, and mechanically strong hydrogel electrolytes in accordance with several embodiments can offer long-term stabilities (at least 1000 cycles at about 5 mA/cm² and 25° C.; or at least 3000 cycles at about 0.5 mA/cm² and −20° C.) and impact resistance (at least 10 times better than the glass fiber).

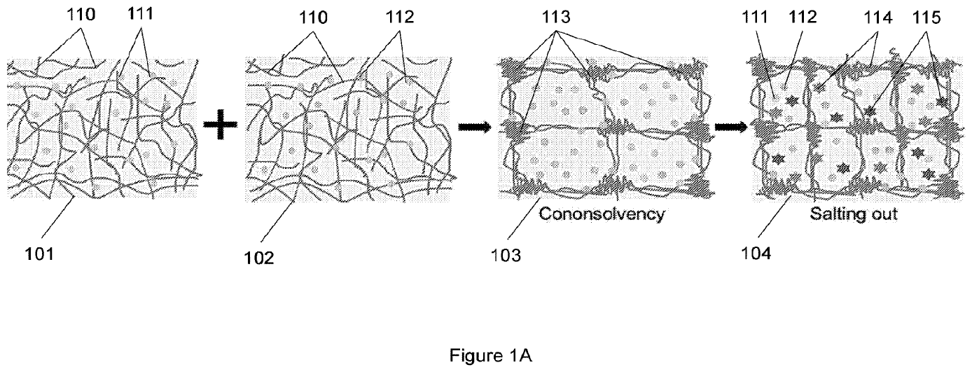

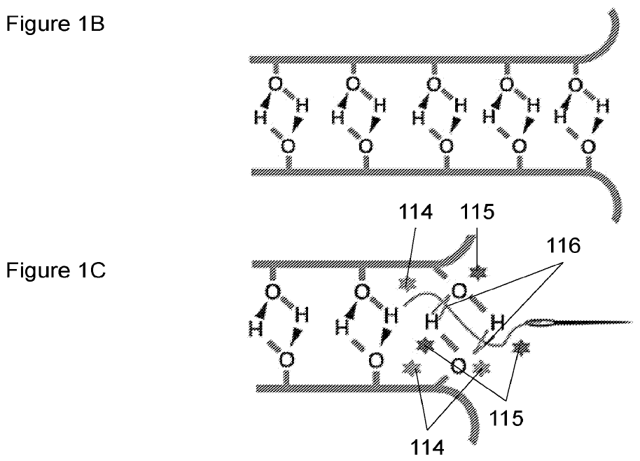

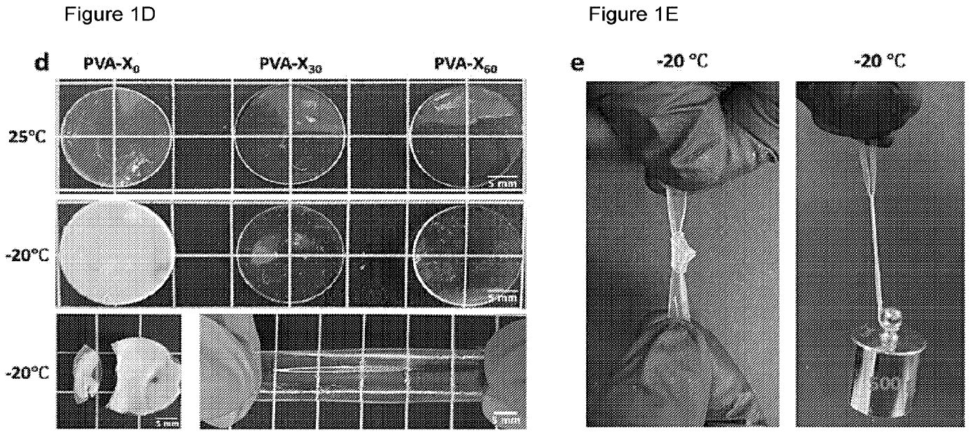

FIG. 1A illustrates a fabrication process of the PVA hydrogel electrolyte in accordance with an embodiment. PVA-in-H₂O solution 101 includes the polymer chains 110 and the water molecules 111. PVA-in-DMSO solution 102 includes the polymer chains 110 and the DMSO molecules 112. PVA-in-DMSO 102 and PVA-in-H₂O 101 solutions can be mixed. The mixture 103 can be put in a mold (not shown) for gelation. Through the mixing of the two solutions, PVA crystallites 113 formation are facilitated through the formation of intermolecular hydrogen bonds, which serve as the physical crosslinking sites. After the gelation, the hydrogels can be immersed in various concentrations of ZnSO₄/DMSO/H₂O solutions to form the hydrogel electrolytes 104. The zinc ions (Zn²⁺) 114 and the sulfuric ions (SO₄²⁻) 115 can enhance the polymer chain aggregation due to the Hofmeister “salting-out” effect and enhance the mechanical strength of the hydrogel electrolyte 104. The hydrogel electrolytes can be named according to the DMSO concentrations (PVA-X₀ to PVA-X₆₀, with increasing DMSO content, Table 1).

FIG. 1B illustrates the hydrogen bond interaction between the PVA polymer chains in accordance with an embodiment. FIG. 1C illustrates the interaction among ions and polymer chains in accordance with an embodiment. The Zn²⁺ ions 114 and SO₄²⁻ ions 115 promote the formation of new hydrogen bonds 116 between the hydroxyl groups forming the aggregation/crystallization of PVA. The Hofmeister “salting-out” effect of ZnSO₄ further increases the chain aggregation and crystallite formation

The presence of DMSO enhances the freezing tolerance of the hydrogel. FIGS. 1D and 1E illustrate flexibility of the hydrogel electrolyte in accordance with an embodiment. FIG. 1D shows photographs of PVA-X₀, PVA-X₃₀, and PVA-X₆₀ at about 25° C. and −20° C. At −20° C., PVA-X₀ became opaque and brittle, and can be easily shattered. In contrast, PVA-X₃₀ and PVA-X₆₀ remain flexible, and can still be stretched as shown in the picture at the bottom right corner. FIG. 1E left panel shows a photo of a knotted PVA-X₃₀ strip at about −20° C., showing its low-temperature flexibility. The right panel shows a photo of a PVA-X₃₀ strip hold a 500 g weight at about −20° C., showing its robustness.

TABLE 1
Weight ratios of the solution components
used to form PVA hydrogel electrolytes.

| | Weight ratio | | |
|---|---|---|---|
| Name | DMSO | H₂O | ZnSO₄•7H₂O |
| PVA-X₀ | 0 | 500 | 287.56 |
| PVA-X₁₀ | 50 | 450 | 287.56 |
| PVA-X₂₀ | 100 | 400 | 287.56 |
| PVA-X₃₀ | 150 | 350 | 287.56 |
| PVA-X₄₀ | 200 | 300 | 287.56 |
| PVA-X₅₀ | 250 | 250 | 287.56 |
| PVA-X₆₀ | 300 | 200 | 287.56 |

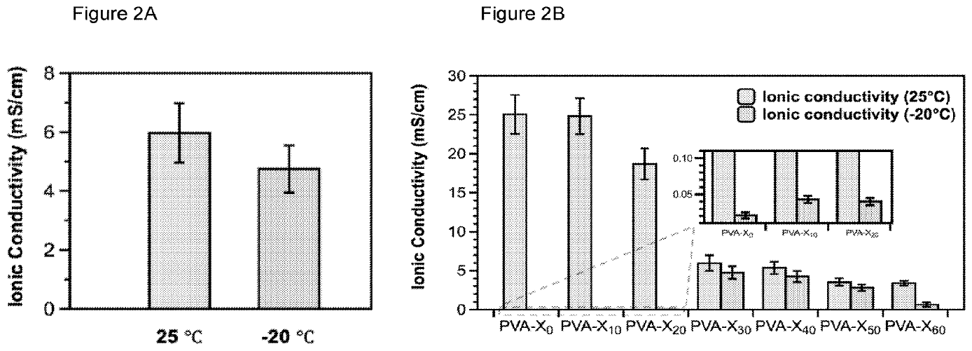

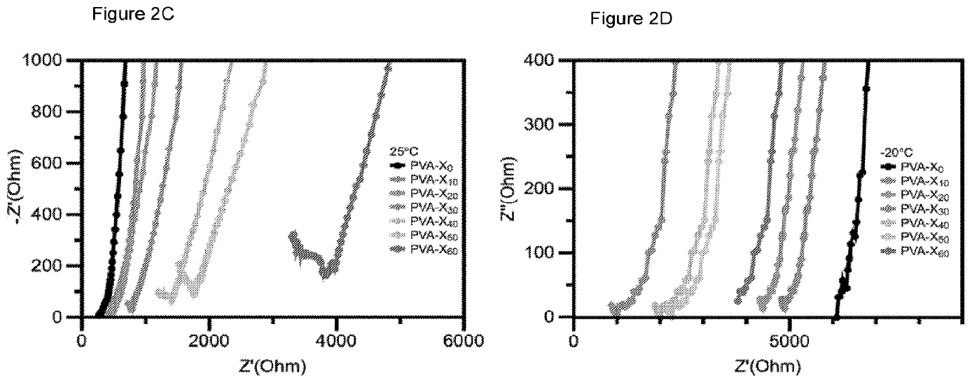

Several embodiments provide the electrolyte hydrogels can serve as tough and anti-freezing electrolytes with desired morphologies, ionic conductivities, stress-strain behaviors, and freezing temperatures. FIGS. 2A-2C illustrate the ionic conductivities of the hydrogel electrolytes in accordance with an embodiment. FIG. 2A illustrates ionic conductivities of PVA-X₃₀ tested at 25° C. and −20° C. FIG. 2B illustrates ionic conductivities of various hydrogel electrolytes tested at 25° C. and −20° C. FIGS. 2C and 2D illustrate Nyquist plots of the ionic conductivity experiments at 25° C. and −20° C. respectively. At 25° C., the PVA-X₀ has the highest ionic conductivity (25 mS/cm). However, at −20° C., the ionic conductivities of PVA-X₀, PVA-X₁₀, and PVA-X₂₀ are lower than about 0.05 mS/cm due to the freezing of the liquid inside the hydrogels. PVA-X₃₀ shows the highest ionic conductivity at −20° C. of about 4.743 mS/cm. The ionic conductivity starts to decrease with increasing DMSO content inside the hydrogel from PVA-X₄₀ to PVA-X₆₀. Two factors might contribute to this phenomenon: higher DMSO content may lead to decreased pore sizes and/or decreased of ion mobility due to the increased size of ion complexes.

Several embodiments provide that salts that can have the Hofmeister salting-out effect on the hydrogel electrolyte are selected for production. The Hofmeister “salting-out” effect of ZnSO₄ on PVA can be demonstrated by dropping the PVA solution into the ZnSO₄/DMSO/H₂O solution. When mixing the PVA solution with the ZnSO₄/DMSO/H₂O solution, white and opaque clumps appear in the mixture. This means that upon contacting ZnSO₄ solution, the once soluble PVA start to precipitate and aggregate, showing ZnSO₄ has a strong Hofmeister “salting-out” effect on PVA. In contrast, when mixing the PVA solution with a zinc chloride (ZnCl₂) solution or a zinc perchlorate (Zn(ClO₄)₂)) solution, the mixtures are transparent and PVA stays soluble in the mixtures, showing the weak Hofmeister “salting-out” or even Hofmeister “salting-in” effect. These salts (zinc chloride and zinc perchlorate) might enhance the solubility of the polymer and degrade the robustness of the PVA hydrogel.

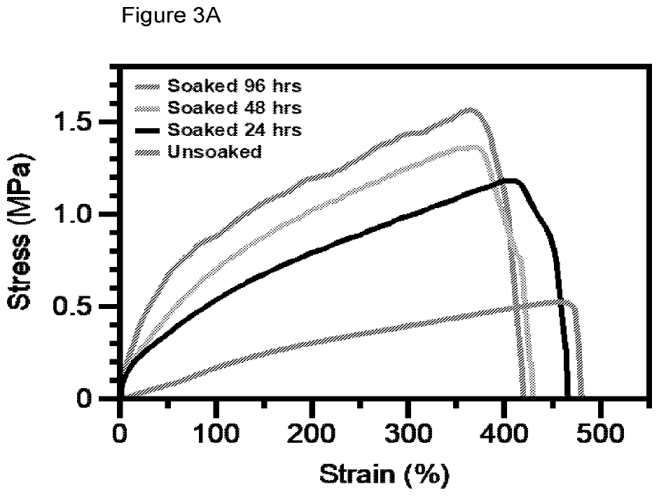

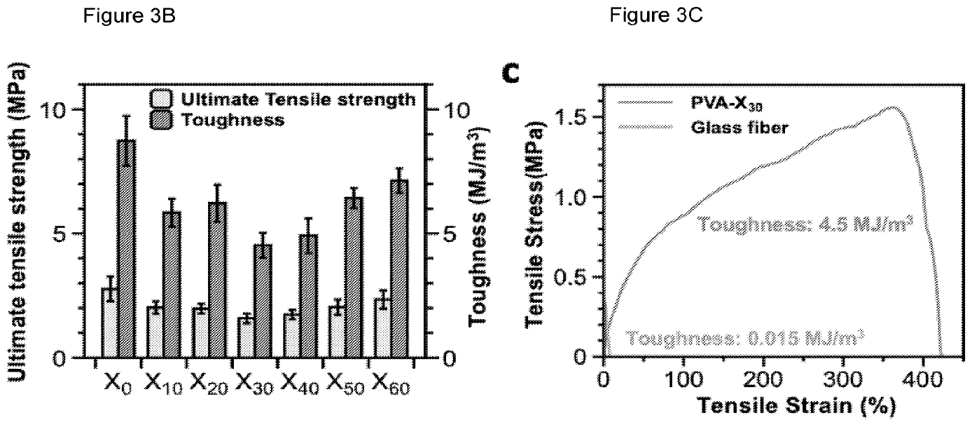

Some embodiments provide that the soaking time can affect the mechanical properties. FIGS. 3A-3C illustrate mechanical properties of the electrolyte hydrogels in accordance with an embodiment. FIG. 3A shows stress-strain curves of the PVA hydrogels soaked in X₃₀ liquid electrolyte for Oh, 24 h, 48 h, and 96 h. Before soaking into the DMSO/H₂O/ZnSO₄ solution, the ultimate tensile strength and toughness of the PVA hydrogels are 0.4 MPa and 1.2 MJ/m³, respectively. During the soaking process, polymer chains gradually aggregate and form crystalline domains, leading to the increase in strength as shown in FIG. 3A. FIG. 3B shows the ultimate tensile strength and toughness of different hydrogel samples (PVA-X₀ to PVA-X₆₀). After 96 h, the ultimate tensile strength and toughness for PVA-X₀, PVA-X₃₀ and PVA-X₆₀ reach 2.8 MPa and 8.75 MJ/m³, 1.585 MPa and 4.56 MJ/m³, 2.1 MPa and 6.73 MJ/m³, respectively. PVA-X₀ and PVA-X₆₀ are stronger than PVA-X₃₀, which may be due to the smaller pore sizes. FIG. 3C shows the stress-strain curves of PVA-X₃₀ and commercial glass fiber. Despite the PVA-X₃₀ not as strong as the other tested hydrogel electrolytes, it is still much stronger than the commercial glass fiber separator which is commonly used in the zinc-ion batteries, showing 5 times and 300 times the ultimate tensile strength and toughness, respectively.

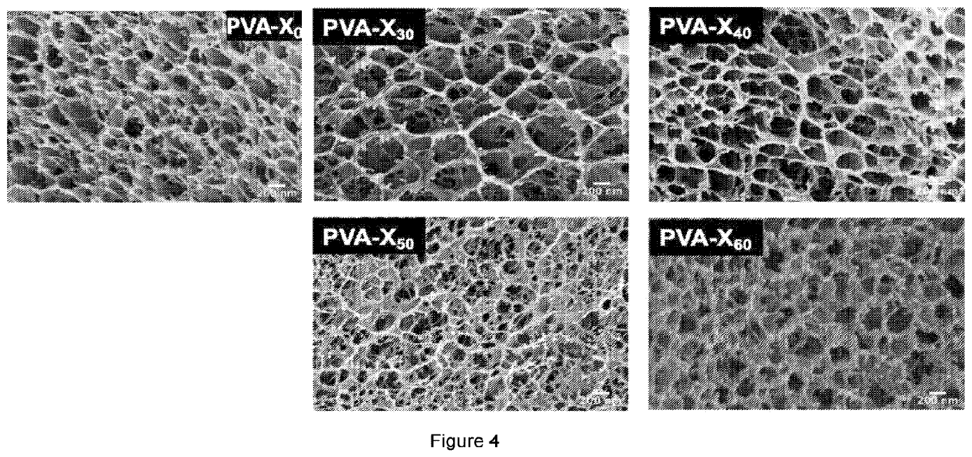

FIG. 4 illustrates SEM images of the hydrogel electrolytes in accordance with an embodiment. FIG. 4 shows the SEM images of PVA-X₀, PVA-X₃₀, PVA-X₄₀, PVA-X₅₀ and PVA-X₆₀. PVA-X₃₀ has the largest pore sizes compared to the rest of the tested hydrogel electrolytes.

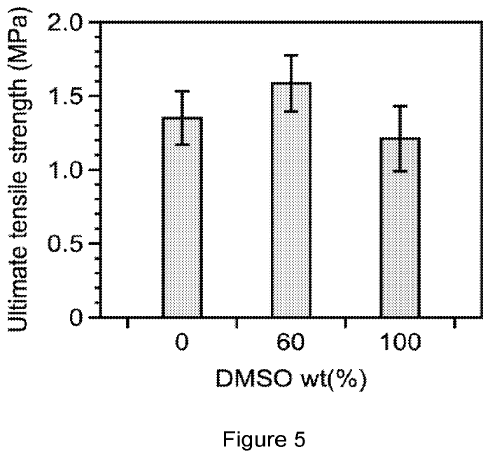

Beside Hofmeister “salting-out” effect, utilization of solvent mixture can contribute to the robustness. FIG. 5 illustrates the mechanical property of the PVA hydrogel electrolytes in accordance with an embodiment. The PVA hydrogel electrolytes are formed by using the cononsolvency effect (60 wt %) and without cononsolvency effect (0 wt % and 100 wt %). 0 wt % DMSO and 100 wt % DMSO PVA hydrogels are prepared and soaked in X₃₀ solution, and are compared with PVA-X₃₀, which is prepared in a mixture of DMSO and H₂O. Comparing to PVA-X₃₀, the PVA hydrogel electrolyte formed by 0 wt % DMSO and 100 wt % DMSO through freeze-soak method show lower tensile strength. The phase separation induced by the cononsolvency effect can generate thicker pore walls, which can lead to higher tensile strength.

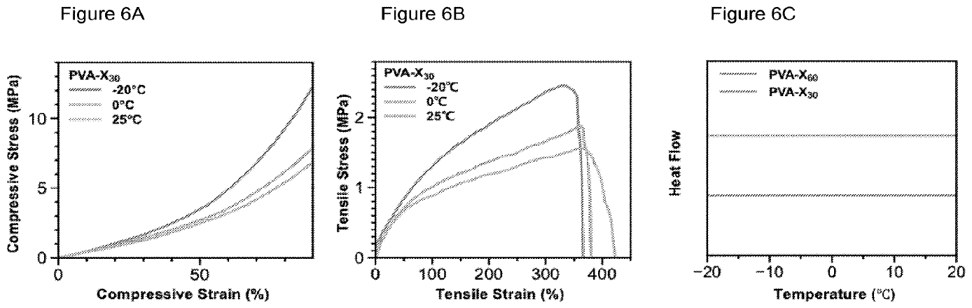

To demonstrate the anti-freezing property of the hydrogel, many embodiments provide mechanical and thermal characterizations. FIGS. 6A and 6B illustrate the compressive and tensile stress-strain curves of PVA-X₃₀ at 25° C., 0° C., and −20° C. in accordance with an embodiment. No sudden breakage is observed in the compression tests when compressive strain reaches about 90% at about 25° C., 0° C., and −20° C. As shown in FIG. 6B, little change in the elongation at break is observed with decreasing temperature, and the hydrogel still have greater than about 350% stretchability at about −20° C. instead of brittle fracture. The freezing temperatures of the hydrogels can be measured with a differential scanning calorimeter (DSC). FIG. 6C illustrates the DSC curves of PVA-X₃₀ and PVA-X₆₀ in accordance with an embodiment. No peak is observed for the PVA-X₃₀ and PVA-X₆₀ within the temperature window of 20° C. to −20° C., demonstrating that the freezing temperature is lower than −20° C. The anti-freezing property might be the result of the strong interaction between the DMSO and water molecules.

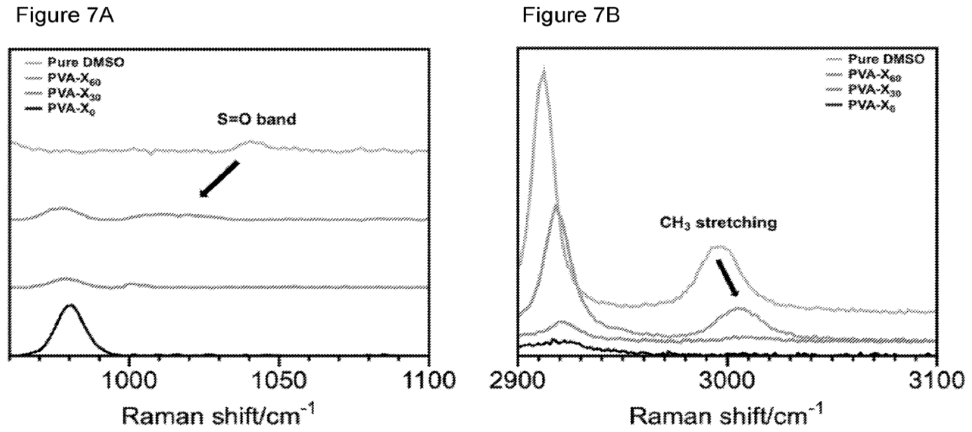

FIGS. 7A and 7B illustrate Raman spectra of the pure DMSO and PVA hydrogel electrolytes in accordance with an embodiment. FIGS. 7A and 7B show the Raman spectra of pure DMSO, PVA-X₀, PVA-X₃₀ and PVA-X₆₀. The shifting of the S═O and CH₃ band with increasing DMSO concentration proves that water molecules could be attracted by the DMSO, and form sturdy S═O··H—O hydrogen bonds, which regulates the free water molecules inside the solution and decreasing the freezing temperature.

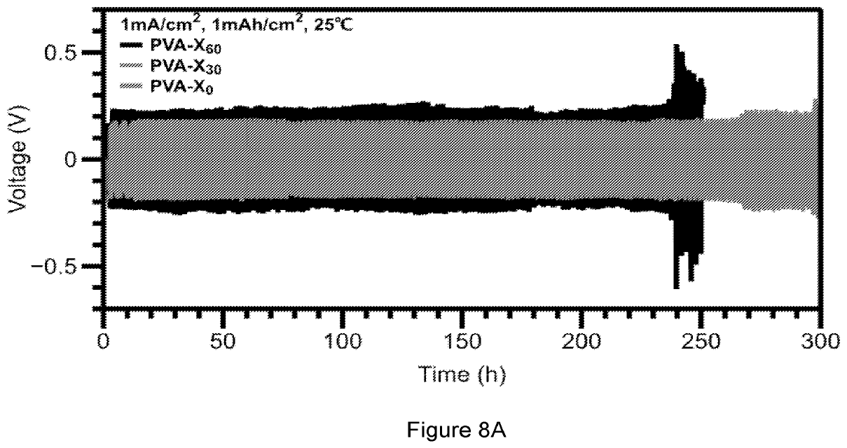

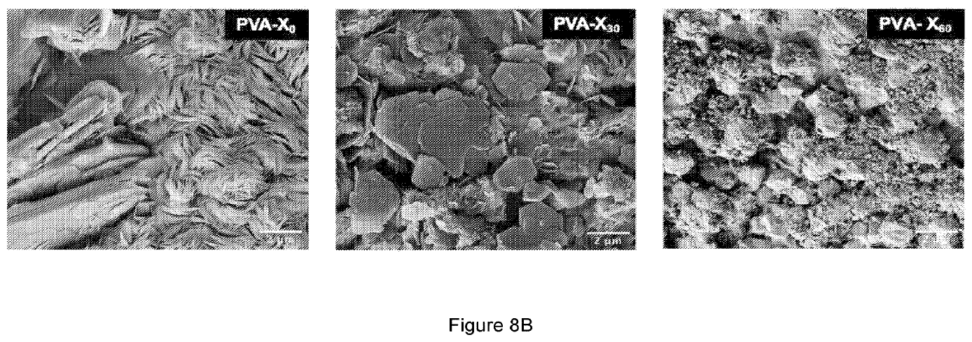

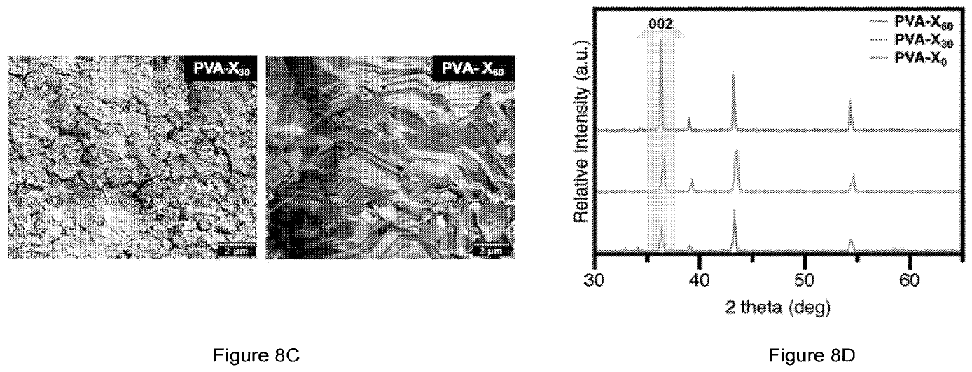

In several embodiments, the hydrogels are deployed in Zn/Zn or Zn/PANi cells to showcase their ability as anti-freezing zinc-ion battery electrolytes. When tested at 1 mA/cm², 1 mAh/cm², and 25° C. The Zn/Zn cells using PVA-X₃₀ and PVA-X₆₀ electrolytes can stay stable over 300 h and 230 h, respectively, without significant fluctuation. FIG. 8A illustrates the voltage profiles of the Zn/Zn symmetric batteries with PVA-X₀, PVA-X₃₀, and PVA-X₆₀ electrolytes at 1 mA/cm², 1 mAh/cm², and 25° C. in accordance with an embodiment. However, the cells with PVA-X₀ is only stable for 60 h before shorting due to the dendrite formation. FIG. 8B illustrates Surfaces SEM images of the Zn foils in Zn/Zn batteries after 50 cycles at 1 mA/cm², 1 mAh/cm², and 25° C. with PVA-X₀, PVA-X₃₀, PVA-X₆₀ as electrolytes in accordance with an embodiment. SEM images of the Zn foils in the Zn/Zn cells after 50 cycles are collected to characterize the dendrites. The usage of PVA-X₀ leads to the appearance of many sharp dendrites, comprising several zinc hexagonal plates grown over each other in the vertical direction. In contrast, sharp dendrites are not observed from the cell using PVA-X₃₀ and PVA-X₆₀. In the case of PVA-X₃₀, the zinc hexagonal plates tend to grow in horizontal direction along the Zn metal surface. FIG. 8C illustrates surfaces SEM images of the Zn foils in Zn/Zn batteries after 200 cycles at 1 mA/cm², 1 mAh/cm², and 25° C. with PVA-X₃₀ and PVA-X₆₀ as electrolytes in accordance with an embodiment. SEM images of the Zn foils after 200 cycles with PVA-X₃₀ and PVA-X₆₀ are collected. No sharp dendrites were observed.

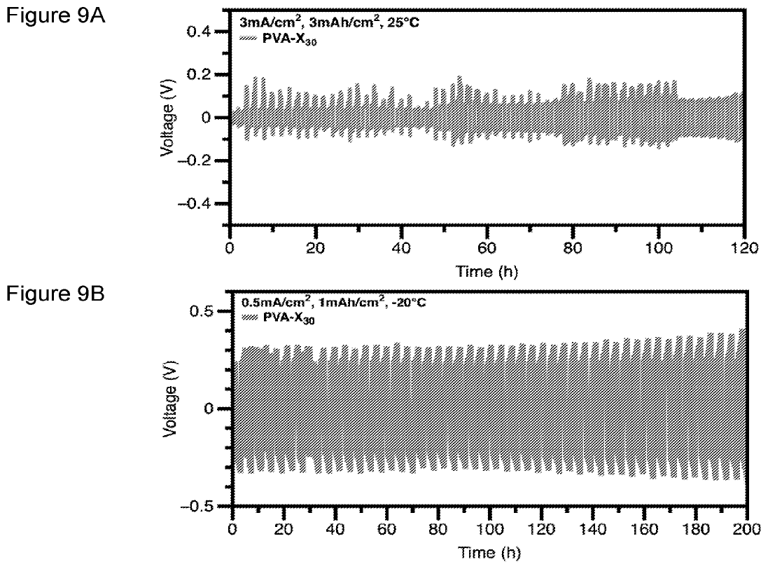

X-ray diffraction (XRD) can be used to evaluate the products of the Zn plating with different hydrogel samples after 50 cycles. FIG. 8D illustrates XRD patterns of the Zn foils in Zn/Zn batteries after 50 cycles at 1 mA/cm², 1 mAh/cm², and 25° C. with PVA-X₀, PVA-X₃₀, PVA-X₆₀ as electrolytes in accordance with an embodiment. As shown in FIG. 8D, with increasing DMSO concentration, the peak at 2θ=36.5° becomes stronger compared to the other peaks, indicating that higher DMSO concentration can promote the lateral deposition on the (002) plane more effectively, which reduces dendrite growth and leads to longer battery life. While PVA-X₆₀ is most effective in dendrite resistance, its small pore sizes as well as bulkier ion complexes hinders the mass transport and leads to the earlier occurrence of voltage polarization compared to PVA-X₃₀. The stability of PVA-X₃₀ is further demonstrated by testing Zn/Zn cells at 3 mA/cm², 3 mAh/cm², and 25° C., and at 0.5 mA/cm², 1 mAh/cm², and −20° C. FIGS. 9A and 9B illustrate the voltage profiles of the Zn/Zn symmetric batteries with PVA-X₃₀ at 3 mA/cm², 3 mAh/cm² and 25° C., and 0.5 mA/cm², 1 mAh/cm² and −20° C. in accordance with an embodiment. FIGS. 9A and 9B show the stability and freezing tolerance of the PVA-X₃₀ electrolyte.

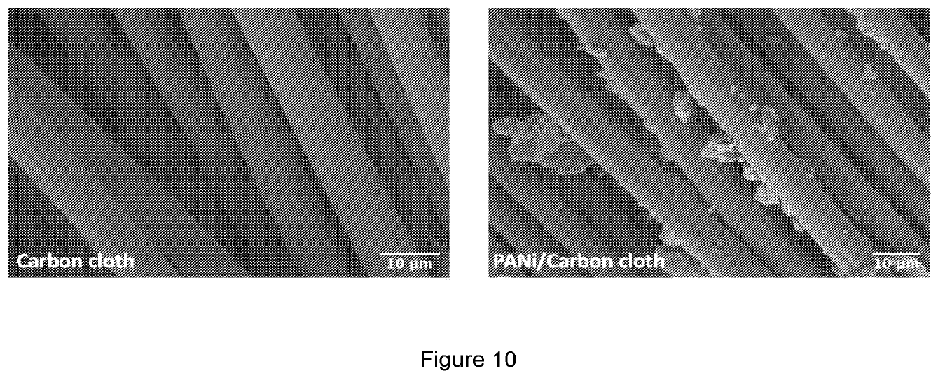

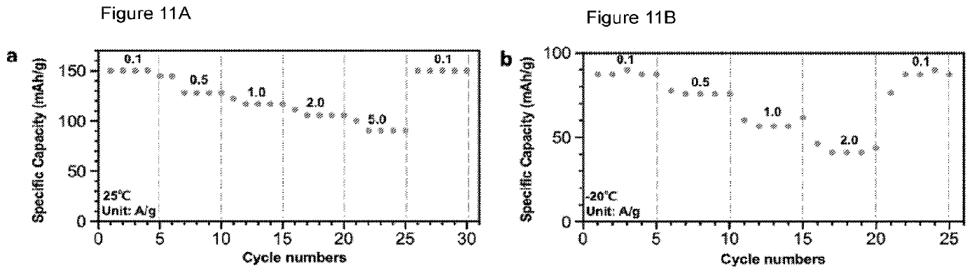

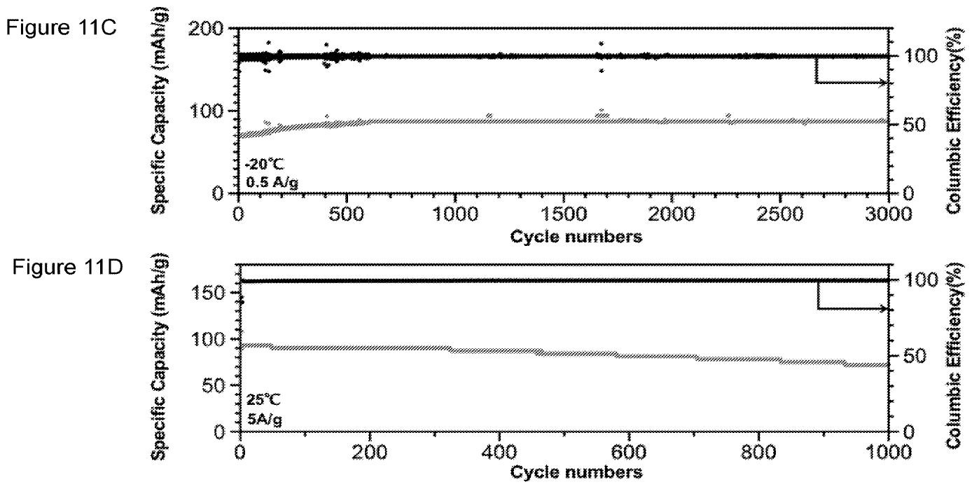

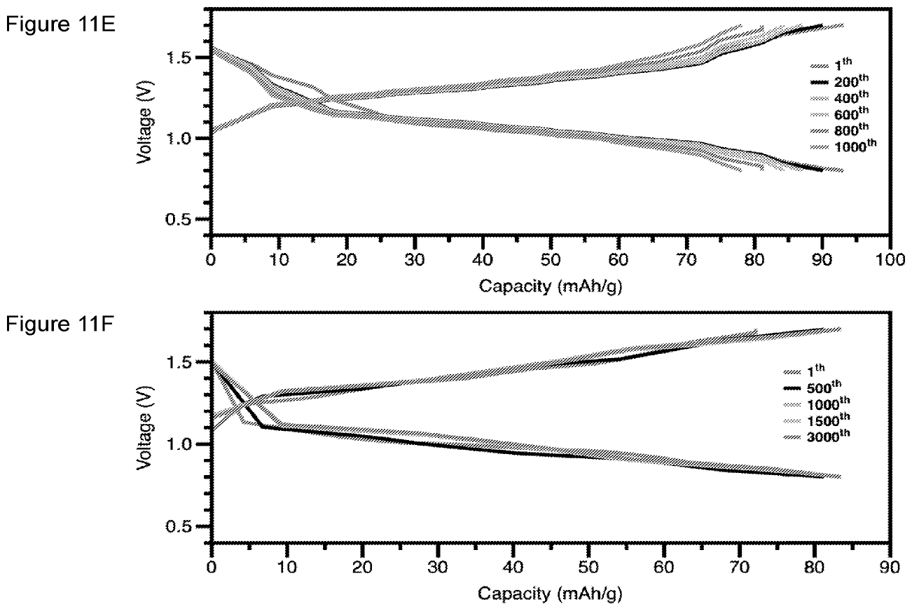

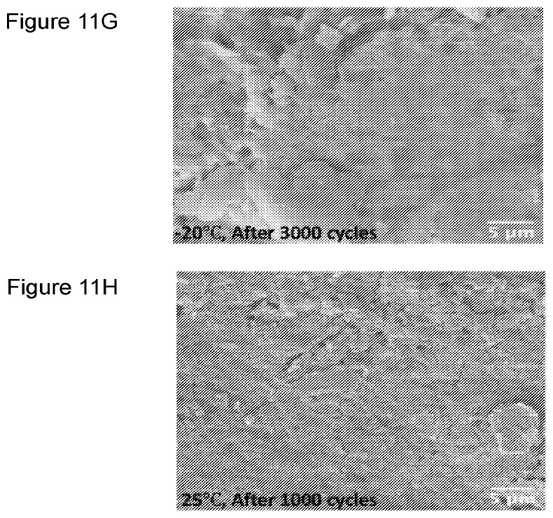

Zn/polyaniline (PANi) full batteries are tested to show the practical application of PVA-X₃₀. PANi is used as the cathode, owing to its high conductivity and inherent elasticity which benefit the cycle stability. FIG. 10 illustrates SEM images of the carbon cloth and the carbon cloth with PANi in accordance with an embodiment. The SEM images show that the PANi can be successfully grown on the carbon cloth. FIGS. 11A-11H illustrate rate performances, cycle performances, and SEM images of the Zn/polyaniline batteries with PVA-X₃₀ in accordance with an embodiment.

The rate performances of the Zn/polyaniline batteries at 25° C. and −20° C. are shown in FIGS. 11A and 11B. The battery provides a reversible capacity of about 90 mAh/g at a current density of about 5 A/g at 25° C. At −20° C., the battery shows capacity as high as 87 mAh/g at 0.1 A/g, and could maintain that same value after cycling at higher current densities; this indicates that the lower capacity at higher current density is mainly influenced by transport kinetics rather than structural degradation of PVA-X₃₀.

The cycle performances of the Zn/PANi batteries with PVA-X₃₀ is evaluated at 0.5 A/g at −20° C. and 5 A/g at 25° C., as shown in FIGS. 11C and 11D. FIGS. 11E and 11F illustrate the galvanic charge/discharge curves of the Zn/PANi batteries with PVA-X₃₀ at different cycles at 5 A/g and 25° C., and 0.5 A/g and −20° C. respectively. At 25° C., the battery exhibits a high capacity of about 78 mAh/g after 1,000 cycles. At −20° C., the capacity remains at about 83 mAh/g after 3,000 cycles. Both cycle tests show almost 100% columbic efficiency for the entire testing duration.

FIGS. 11G and 11H show SEM images of the Zn anode in the Zn/PANi batteries after cycling at −20° C. and 25° C. respectively. The surfaces of the Zn metal remain smooth after battery cycling at both 25° C. and −20° C., and no vertical zinc dendrites are observed. The excellent dendrite-suppressing property can benefit the long-term stability of the batteries.

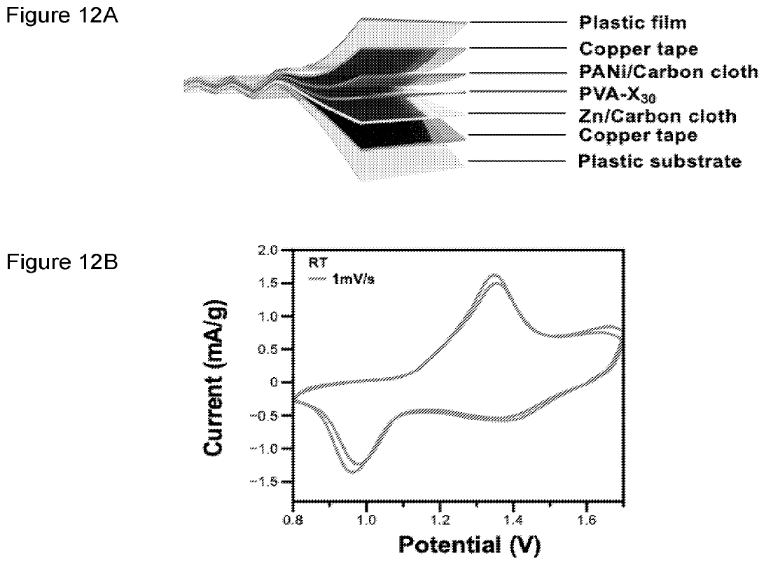

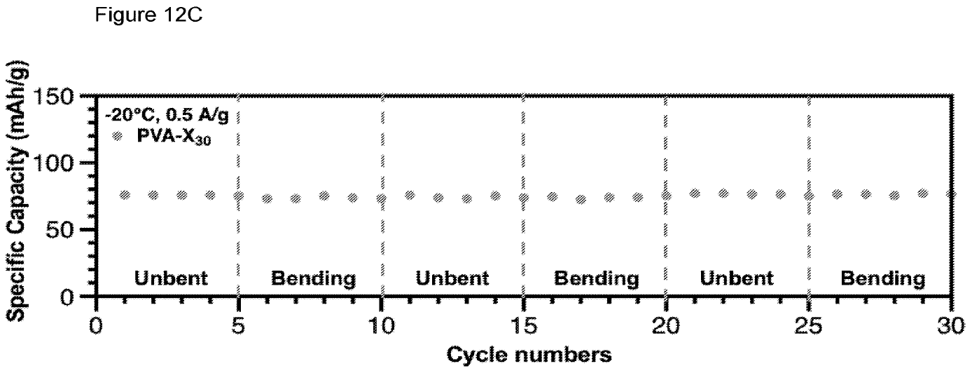

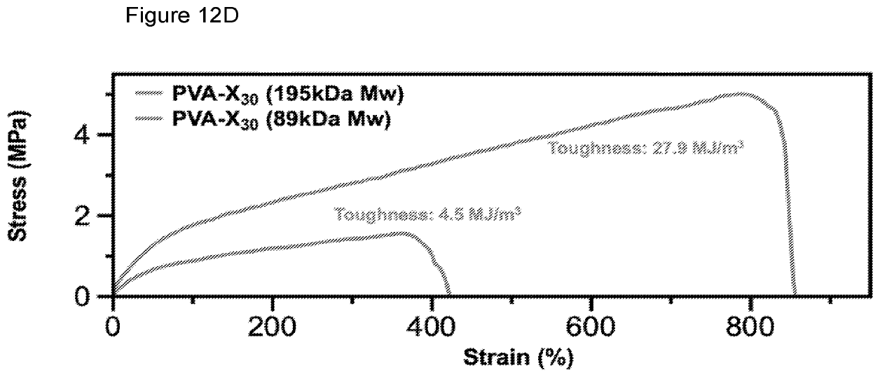

Soft-pack batteries can be assembled to further study the battery performance under mechanical deformation or impact. FIG. 12A illustrates a schematic of the soft-pack Zn/PANi battery with PVA-X₃₀ in accordance with an embodiment. FIG. 12B illustrates the CV curves of the battery at 1 mV/s at 25° C. in accordance with an embodiment. Cyclic voltammetry curves show peaks at about 1.35 V and 0.95 V vs Zn/Zn²⁺ corresponding to the storage/release of ions from the PANi. The battery is anti-freezing and is tough enough to endure the hammering without shorting while still being able to light up the LED bulb. The soft-pack Zn/PANi battery can light up a LED, even after being soaked in the ice bath or hammered. Low temperature bending tests are conducted to show the flexibility and anti-freezing property of the battery. FIG. 12C illustrates specific capacity during the bending test of the Zn/PANi battery with PVA-X₃₀ at 0.5 A/g and −20° C. in accordance with an embodiment. As shown in FIG. 12C, the PVA-X₃₀ battery is first tested in the unbent state for 5 cycles, then it is bent during the subsequent 5 cycles; and so on. The battery's capacity remains stable at about 75 mAh/g after 30 cycles. This test shows that the hydrogel electrolytes can offer outstanding mechanical property and durability in practical situations.

Hitting tests are conducted to further demonstrate the durability. A weight can be repeatedly dropped on the soft-pack batteries from a certain height (for example, a weight of about 500 g and a height of about 8 cm). After a first drop of the weight onto the battery, the battery with the glass fiber separator can no longer light up the LED bulb. In contrast, the PVA-X₃₀ battery can still light up the LED bulb after 10 hits. Photos of these two batteries after the hitting test show that the glass-fiber separator is smashed during the hitting test, which can cause shorting. In contrast, no apparent physical damage can be found on the PVA-X₃₀ battery, proving its higher durability.

In some embodiments, stronger hydrogels can be made using a similar synthesis process for the PVA/ZnSO₄/DMSO/H₂O hydrogel electrolyte by changing the molecular weight of the PVA from about 89 kDa to about 195 kDa, which can lead to 3 and 6 times increase in tensile strength and toughness, respectively. The hydrogel made with 195 kDa PVA is strong enough to hold a five-gallon bottle of water, showcasing its robustness. FIG. 12D illustrates the stress-strain curves of PVA-X₃₀ made with PVAs of different molecular weights in accordance with an embodiment. The toughness increases about 6 times through increasing the MW of PVA from 89 kDa to 195 kDa.

### Organic Solvent Free, Tough, and Anti-Freezing Hydrogel Electrolytes

Many embodiments provide hydrogel electrolytes that have anti-freezing properties, high mechanical robustness, enhanced mass transport, and suppressed dendrites and side reactions. Many embodiments provide fabrication processes harnessing the synergistic effect of cononsolvency and Hofmeister “salting-out” that can produce poly(vinyl alcohol) hydrogel electrolytes with open-cell porous structures, composed of strongly aggregated polymer chains, and containing disrupted hydrogen bonds among free water molecules. The hydrogel electrolytes can be made synergistically utilizing cononsolvency and Hofmeister “salting-out” with KAc/ZnAc₂ solution. The hydrogel electrolyte simultaneously combines high strength (tensile strength 15.6 MPa), freeze-tolerance (<−77° C.), high mass transport (10× lower overpotential), and dendrite and parasitic reactions suppression for stable performance (30,000 cycles). The quasi-solid state anti-freezing battery made with this hydrogel electrolyte exhibit capacity retention over 30,000 cycles at 2 A g⁻¹ at −20° C. and could withstand repeated impact from a hammer or run-over by a vehicle. In several embodiments, poly(N-isopropylacrylamide) and poly(N-tertbutylacrylamide-co-acrylamide) hydrogels can be made with similar methods.

Safe and stable operation of robust batteries that can power the systems such as wearable devices and soft robotics play an important role in improving healthcare, energy, environments, and machine autonomy and intelligence. Mechanically, wearable electronic devices and soft robots experience various mechanical impacts or complex deformations such as hitting, tearing, and puncturing. Thermally, they need to endure 0° to −20° C. for space exploration and from −40° C. to −61° C. in high latitude or altitude areas. The batteries as their power supply components also need to be soft and flexible, impact resistant, and anti-freezing. Soft electrolyte materials (including separators) capable of maintaining desired ionic conductivity and withstanding the impacts to prevent shorting and resist dendrite growth for battery stability under a range of temperatures are in need.

While lithium batteries with organic electrolytes face challenges such as depleting limited-reserve-elements (e.g., cobalt), toxicity, high reactivity, and flammability, and solid electrolytes fall short in conductivity, aqueous zinc batteries have attracted interest due to their intrinsic safety, eco-friendliness, and low production cost. Within aqueous systems, quasi-solid hydrogel electrolytes may outperform liquid electrolytes, as they can be leakage-free, suppress dendrite growth, and inhibit hazardous side reactions, while maintain flexibility. Anti-freezing hydrogel electrolytes were developed through adding organic solvent or concentrated salts, polymer modification, etc. However, a hydrogel electrolyte that is mechanically robust, thermally stable, and mass transport friendly is yet to be developed. Previously reported anti-freezing strategies by salts or additives can harm the mechanical strength. For example, the addition of calcium chloride, zinc perchlorate, zinc nitrate, zinc triflate, zinc iodide, or ethylene glycol suppresses the freezing temperature but deteriorates the ultimate tensile strength, fracture toughness, toughness, and elongation at break of the hydrogel due to the Hofmeister “salting-in” effect which decreases the polymer aggregation. As a result, most existing anti-freezing hydrogel electrolytes are mechanically weak and cannot match the strength of the commercial separator or NASA standards. Secondly, strength and mass transport can be inversely correlated. Strong polymers generally possess high crystallinity and solid content, while ionic conduction is favored in the amorphous or porous structure, which compromises strength. Thirdly, organic additives sacrifice the intrinsic safety of the aqueous system and inhibit salt ion solvation, leading to precipitations that may compromise the low-temperature performance.

Many embodiments synergistically employ the cononsolvency effect from the polymer's mixed solvents and Hofmeister “salting-out” effect from an anti-freezing salt solution to produce mechanically robust, anti-freezing, high-mass-transport, and organic solvent-free hydrogel electrolytes. Hofmeister “salting-out” ions, such as K⁺ and acetate, are effective in toughening hydrogels via ion-promoted chain aggregation while maintaining high water content. Cononsolvency also influences the chain aggregation, where adding cosolvent to the precursor promotes the formation of open-cell porous structures with densified polymer network, thus enhancing both mass transport (10 times lower overpotential compared to the less porous counterparts) and strength. The Hofmeister “salting-out” effect can be achieved by a salt mixture: potassium acetate (KAc), which combines Hofmeister “salting-out” and anti-freezing abilities, mixed with zinc acetate (ZnAc₂), a compatible Zn²⁺ containing salt. Poly(vinyl alcohol) (PVA) is chosen as the exemplary polymer because it exhibits both Hofmeister “salting-out” and cononsolvency effects. Benefitting from both effects, such a hydrogel, as a wet material containing mostly liquid, is even stronger than dry wristbands materials (15.6 MPa vs. 11.6 MPa). The hydrogel electrolyte is compatible with the polyaniline cathode (composed of abundant elements) and can be made into highly stable batteries at low temperatures (>30,000 cycles at −20° C., negligible decrease in capacity). This presents its potential to be used in soft devices, which demand mechanical and electrochemical durability in harsh environment.

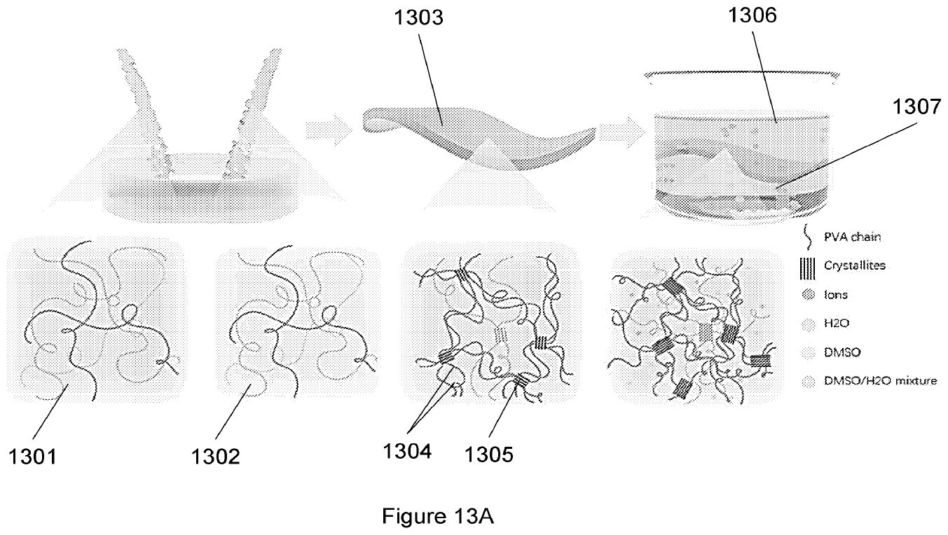

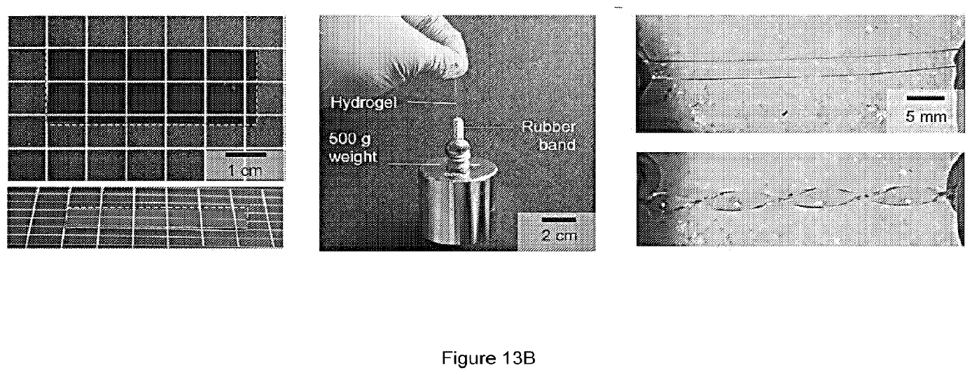

FIG. 13A illustrates a schematic of fabricating a hydrogel electrolyte with a dual salt solution in accordance with an embodiment. The PVA/water 1301 and PVA/DMSO 1302 solutions are mixed to induce cononsolvency to form a hydrogel 1303 comprising PVA chains 1304 and crystallites 1305. The hydrogel 1303 is then soaked in a salt solution 1306 containing various ions 1307 to go through the Hofmeister “salting-out” process to form the toughened hydrogel electrolyte. FIG. 13B illustrates flexibility of the hydrogel electrolyte in accordance with an embodiment.

A Zn²⁺-containing salt solution that exhibits both Hofmeister “salting-out” and anti-freezing abilities is needed to achieve the desired electrolyte properties. While a single salt that satisfies three criteria may not exist, a salt mixture can be used. Table 2 summaries properties of different salt solutions. The salt mixture can include a first salt for Hofmeister “salting-out” and anti-freezing, and a second salt containing Zn²⁺ ions that can form a homogeneous mixture with the first salt.

TABLE 2
Properties of different salt solutions

| | | Anti- | | Zn²⁺- |
|---|---|---|---|---|
| Type | Salts | freezing < −30° C.? | Salting-out? | containing? |
| Zn²⁺-containing salts | ZnSO₄ | No | Yes | Yes |
| | ZnCl₂ | Ye | No | Yes |
| | Zn(OTF)₂ | No | No | Yes |
| | Zn(TFSl)₂ | Yes | No | Yes |
| | Zn(ClO₄)₂ | Yes | No | Yes |
| | ZnAc₂ | No | Yes | Yes |
| | Zn(NO₃)₂ | No | No | Yes |
| Anti-freezing salts | CaCl₂ | Yes | No | No |
| | LiCl | Yes | No | No |
| “Salting-out” salts | Na₂SO₄ | No | Yes | No |
| | Na₂CO₃ | No | Yes | No |
| | potassium | Yes | Yes | No |
| | citrate tribasic | | | |
| | Sodium citrate | No | Yes | No |
| | tribasic | | | |
| | KAc | Yes | Yes | No |
| | NaAc | Yes | Yes | No |

An example of such a mixture can include (but not limited to) KAc and ZnAc₂. KAc is one of the salts that exhibits the combination of Hofmeister “salting-out” and anti-freezing. In contrast, calcium chloride and zinc perchlorate exhibit anti-freezing and Hofmeister “salting-in” which weakens the hydrogel. Zinc sulfate, sodium sulfate, sodium carbonate, and sodium citrate exhibit Hofmeister “salting-out” effect, but weak anti-freezing abilities. While sodium acetate and potassium citrate exhibit both abilities, their anti-freezing abilities are experimentally measured to be inferior to that of KAc. In addition, potassium acetate can strengthen the PVA polymer chains better compared to sodium acetate, since K⁺ has a stronger Hofmeister “salting-out” effect than Na⁺.

As for ZnAc₂, it can introduce Zn²⁺ ions without introducing an anion that forms precipitates with K⁺ at high concentrations (e.g., SO₄²⁻). Overall, KAc/ZnAc₂ is selected because such a mixture yields a Zn²⁺-containing solution with strong Hofmeister “salting-out” and anti-freezing properties. Acetate ions contained in both salts can suppress the parasitic reactions on the Zn anodes, as an additional benefit.

Several embodiments prepare a plurality of single salt solutions with concentrations close to the solubility limits of the salts at room temperature (mass ratios of salt to water): sodium carbonate 0.4:1, zinc acetate dihydrate 0.357:1, sodium sulfate 0.36:1, sodium citrate tribasic dihydrate 0.6:1, potassium citrate tribasic monohydrate 1.538:1, and zinc nitrate hexahydrate 3.77:1.) Some embodiments prepare a plurality of dual-salt solutions with zinc acetate as the second salt. The dual-salt solutions have concentrations (mass ratios of the first salt to zinc acetate dihydrate to water): potassium citrate tribasic monohydrate 2.2:0.5:3, sodium acetate 1.67:0.5:3, and potassium acetate 2:0.5:3. Such mass ratios are selected so the cation concentrations are the same for all dual-salt solutions. The anion concentrations of the sodium acetate-containing and potassium acetate-containing solutions are also the same. Potassium citrate cannot be used to achieve the same anion concentration as in the potassium acetate-containing solution since that concentration exceeds the solubility limit of potassium citrate. All solutions are homogeneous at room temperature. Among the salt solution samples, the potassium acetate and zinc acetate dual salt solution remains clear after storing at −30° C. for 12 h, which shows anti-freezing properties.

Several embodiments provide solubility of various zinc contain salt in the dual salt solutions. Mixtures of KAc/Zn²⁺-containing salt/H₂O with a 4:1:6 weight ratio at room temperature with three different salt are prepared: zinc acetate dihydrate, zinc(II) trifluoromethanesulfonate, zinc sulfate heptahydrate, and zinc perchlorate hexahydrate. White precipitates appear in the mixture containing zinc sulfate heptahydrate and zinc perchlorate hexahydrate. While the mixture containing zinc(II) trifluoromethanesulfonate remains a clear solution, the use of zinc(II) trifluoromethanesulfonate is less than desirable because of the high cost. Therefore, zinc acetate is chosen as the second salt.

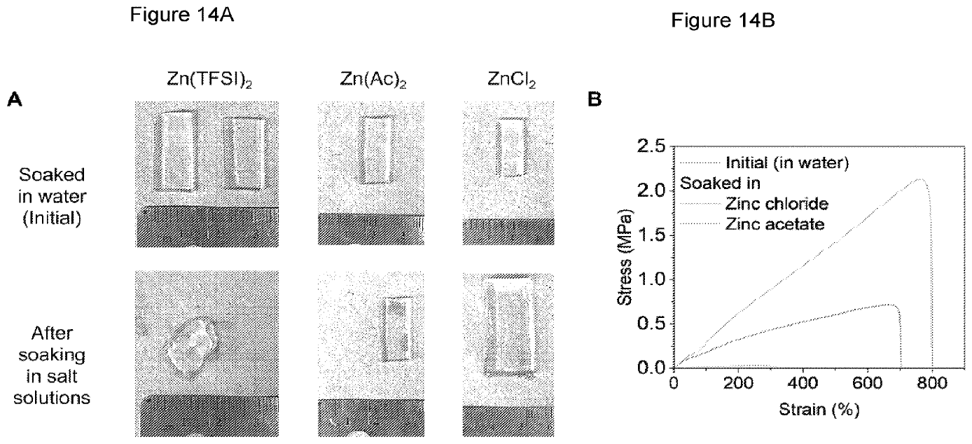

FIGS. 14A and 14B illustrate the Hofmeister effect of the salt solutions in accordance with an embodiment. FIG. 14A shows photos of PVA hydrogels before and after soaking in salt solutions for 2 days Mass ratios of salt to water: Zinc bis(trifluoromethylsulfonyl)imide 0.625:1, zinc acetate dihydrate 0.3:1, and zinc chloride 0.27:1. Both zinc bis(trifluoromethylsulfonyl)imide and zinc chloride salts show Hofmeister “salting-in” effect since the PVA “melted” and swelled after soaking in the solutions, respectively. FIG. 14B illustrates stress-strain curves of the hydrogels. PVA hydrogels soaked in zinc acetate show higher stress compared to the initial stress. PVA hydrogels soaked in zinc chloride show lower stress compared to the initial stress.

Some embodiments provide a solubility limit of KAc in H₂O at room temperature (about 20° C.-25° C.). A solution containing 7.5 g KAc and 2.5 g H₂O stays clear without any precipitates. However, a solution containing 7.5 g KAc and 2 g H₂O stays as a slurry after being put at room temperature for 2 months, showing insolubility of KAc in water at greater than about 75 wt %.

KAc/ZnAc₂ solution can be made into a high concentration due to the high solubility limit of KAc (about 75 wt %) and the fact that KAc can increase the solubility of ZnAc₂. While a high concentration benefits the anti-freezing and Hofmeister “salting-out” ability of the solution, it could impede the ion mobility and cause high overpotential or polarization during battery operation. A series of solutions are used as examples to demonstrate the influence of the salt concentrations to the solution properties, which are named according to the mass ratio of KAc/ZnAc₂·2H₂O/H₂O (named 317, 416, 515, 614, and 713 solutions, respectively, see Table 3). Their solid-liquid transition temperatures are measured by differential scanning calorimetry (DSC), which are below −20° C. for all and decrease with increasing KAc concentration, reaching −39° C. for the 416solution and less than −85° C. for the 515 solution. The anti-freezing ability due to the disrupted hydrogen bonding is evident in the Raman spectroscopy results, in which the relative quantity of the strongly hydrogen-bonded water (3,230 cm⁻¹) and the moderately hydrogen-bonded water (3,420 cm⁻¹) are altered with the addition of the salts. Table 4 summarize Raman spectra intensity ratios of different solutions.

TABLE 3
KAc/ZnAc₂ solution compositions.

| | | | | | Concentration at 25° C. | |
|---|---|---|---|---|---|---|
| | Ingredients (g) | | | Solution density | (mol/L) | |
| Name | KAc | ZnAc₂•2H₂O | H₂O | at 25° C. (g/cm³) | KAc | ZnAc₂ |
| 317 | 3 | 1 | 7 | 1.185 | 3.29 | 0.49 |
| 416 | 4 | 1 | 6 | 1.242 | 4.60 | 0.51 |
| 515 | 5 | 1 | 5 | 1.293 | 5.99 | 0.54 |
| 614 | 6 | 1 | 4 | 1.370 | 7.61 | 0.57 |
| 713 | 7 | 1 | 3 | 1.450 | 9.40 | 0.60 |

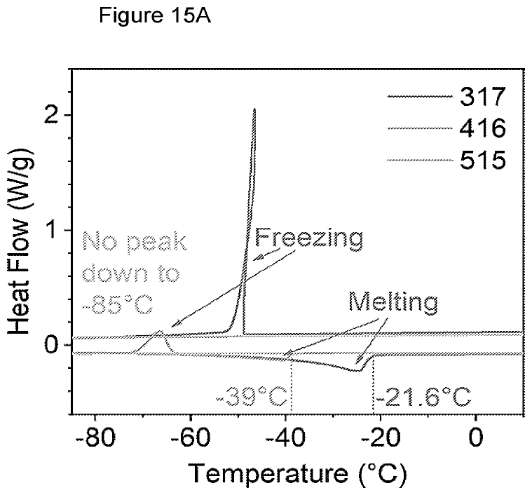

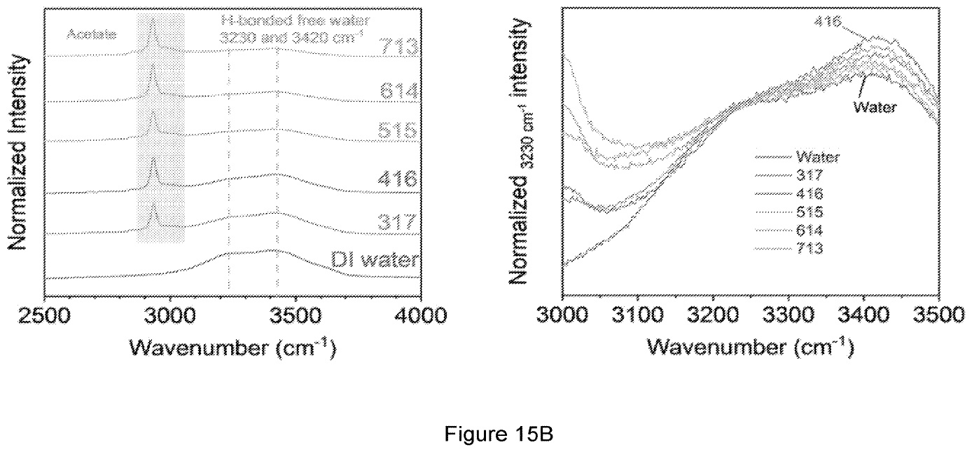

FIGS. 15A and 15B illustrate characterization of KAc/ZnAc₂ solution in accordance with an embodiment. FIG. 15A shows DSC curves of aqueous KAc/ZnAc₂ solutions. FIG. 15B shows Raman spectra of aqueous KAc/ZnAc₂ solutions including a full spectrum and a zoom-in view where the intensities at 3230 cm⁻¹ are normalized for all samples.

TABLE 4
Raman spectra intensity ratios of different solutions.

| Sample | Intensity at 3,420 cm⁻¹/Intensity at 3,230 cm⁻¹ |
|---|---|
| water | 1.093 |
| 317 solution | 1.148 |
| 416 solution | 1.191 |
| 515 solution | 1.111 |
| 614 solution | 1.170 |
| 713 solution | 1.113 |

Aqueous KAc/ZnAc₂ solutions have been reported as stability-window-improving electrolytes while their anti-freezing ability remains elusive. To demonstrate this, Zn—Cu half cells with KAc/ZnAc₂ electrolytes are tested at 25, −20, −30, and −40° C. When lower KAc concentrations are used, the appearance of polarization shifts to lower temperatures and higher current densities. For example, the 515 solution (45 wt % KAc)-containing cell does not show polarization until the current density reaches 0.8 mA cm⁻² at −20° C., while the 614 solution (55 wt % KAc)-containing cell already shows polarization at 0.4 mA cm⁻² current density. In summary, high salt concentration favors anti-freezing ability and mechanical strength, while relatively low concentration benefits battery performance. Based on these results, the 416solution is chosen for its anti-freezing ability (−39° C.) while also supporting decent current densities with reasonable overpotential at low temperature without the appearance of polarization: 1 mA cm⁻², 150 mV, at −20° C., or 0.6 mA cm⁻², 200 mV, at −30° C.

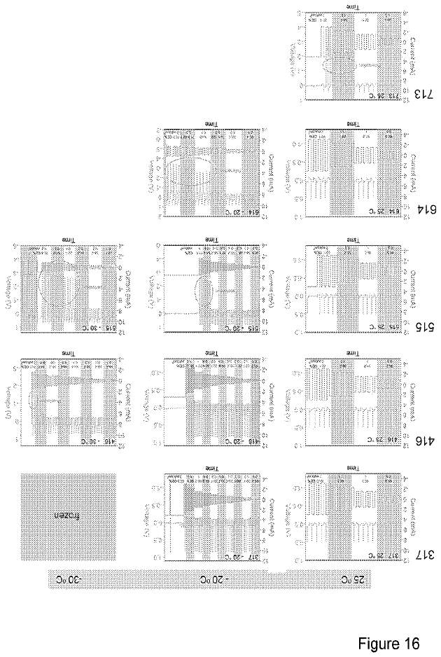

FIG. 16 illustrates voltage profiles of Zn—Cu half cells with aqueous KAc/ZnAc₂ solutions as electrolyte in room temperature (at 0.5, 1, 1.5 and 2 mA/cm² for 1 h), −20° C., and −30° C. (at 0.1, 0.2, 0.3, 0.4, 0.5, 0.6, 0.8, 1, 1.5 and 2 mA/cm² for 1 h). Coulombic efficiencies at different current densities are included at the bottom of the graph. Each current density is tested for 5 cycles. Shades are added to the graph to distinguish cycles with different current densities.

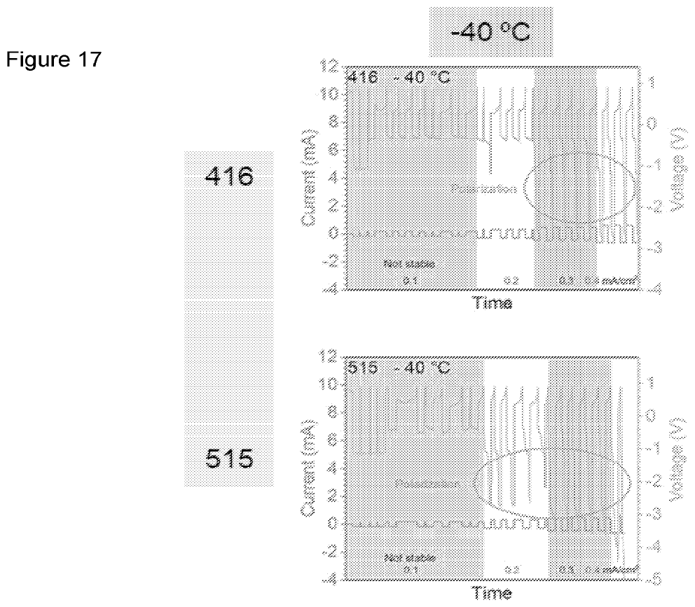

FIG. 17 illustrates voltage profiles of Zn—Cu half cells with aqueous KAc/ZnAc₂ solutions as electrolyte at −40° C. (at 0.1, 0.2, 0.3, 0.4, 0.5, 0.6, 0.8, 1, 1.5 and 2 mA/cm² for 1 h). Coulombic efficiencies at different current densities are included at the bottom of the graph. Each current density is tested for 5 cycles except for 10 cycles for 0.1 mA/cm². Shades are added to the graph to distinguish cycles with different current densities.

Cononsolvency can be an effective approach to generate porous structures with highly densified pore walls and interconnected pores for improving diffusion without compromising mechanical properties, which benefit battery performance. This contrasts with conventional methods where increased porosity can weaken the materials. Two physical descriptions exist for cononsolvency: “solvent complexation,” whereby the two solvents prefer each other over the polymer chains, resulting in a solvent complex as a weak solvent for the polymer and thus chain aggregation, and “preferential adsorption,” whereby one solvent prefers the polymer chains much more strongly than the other does, resulting in the weak solvent exclusion from the polymer matrix and thus polymer chain aggregation. The mechanisms indicate that variables such as chain length, solvent ratio, aging time, and polymer concentration can influence the cononsolvency effect.

Variable tuning can be conducted to produce an optimum hydrogel. First, hydrogels are fabricated with a fixed PVA concentration (10 wt %) with different PVA molecular weights (Mw=31 k-50 k, 89 k-98 k, and ~195 k, degree of hydrolysis >98% for all), and varying DMSO-to-water mass ratios (3:7-8:2). Results show that higher PVA molecular weights (longer PVA chains) yield stronger gels. In addition, longer chains can lead to more entanglements, which also enhances the strength. Comparison among hydrogels with the same PVA molecular weights show that the 6:4 ratio yields the strongest gels. Table 5 lists mechanical properties of 10 wt % open cell PVA before aging.

TABLE 5
Mechanical properties of 10 wt % open-cell PVA before aging

| Chain length | PVA Concentration | DMSO to water ratio | Aging time | Liquid component |
|---|---|---|---|---|
| Various | Fixed, 10 wt % | Various | Fixed, No aging | DMSO/H₂O as |
| | | | time | made, no salt |

| | Tensile Modulus (kPa) | | | Tensile Strength (kPa) | | | Toughness (MJ/m³) | | |
|---|---|---|---|---|---|---|---|---|---|
| | | Mw | | | Mw | | | Mw | |
| DMSO | Mw 31k- | 89k- | | Mw 31k- | 89k- | | Mw 31k- | 89k- | |
| (wt %) | 50k | 98k | Mw 195k | 50k | 98k | Mw 195k | 50k | 98k | Mw 195k |
| 30 | 0 | 11.0 | 2.67 | 0 | 40.0 | 22.7 | 0 | 0.0567 | 0.0868 |
| 40 | 6.67 | 56.7 | 9.33 | 6.50 | 170 | 39.3 | 0.00767 | 0.310 | 0.0860 |
| 50 | 18.6 | 117 | 56.7 | 7.67 | 380 | 577 | 0.00733 | 0.686 | 2.11 |
| 60 | 36.6 | 117 | 90.0 | 9.67 | 493 | 900 | 0.0113 | 1.51 | 4.98 |
| 70 | 28.0 | 103 | 75.0 | 8.33 | 480 | 750 | 0.00667 | 1.48 | 3.15 |
| 80 | 33.3 | 43.3 | 23.3 | 13.2 | 213 | 23.3 | 0.0107 | 0.378 | 1.99 |

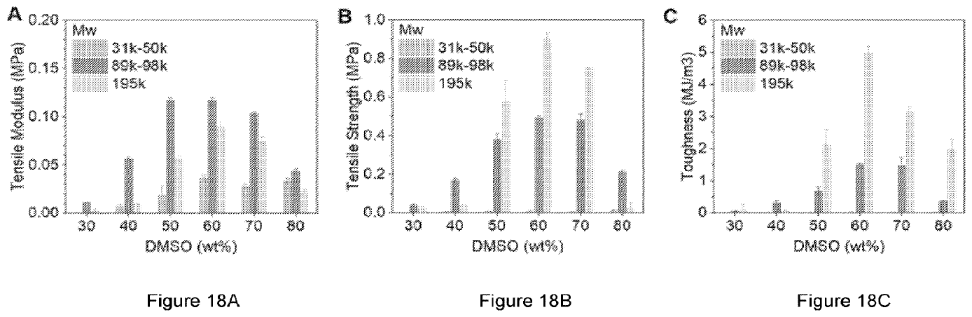

FIGS. 18A-18C illustrate tensile test results of 10% wt PVA hydrogels made with various molecular weights and DMSO to water ratios without aging in accordance with an embodiment. FIG. 18A shows the tensile modulus. FIG. 18B shows the tensile strength. FIG. 18C shows the toughness. Error bars represent standard deviations from 3-4 independent measurements.

Then, the aging effect is studied with PVAs fabricated with a fixed concentration (10 wt %) and solvent ratio (6:4) and varying PVA molecular weights and aging times. Syneresis occurred during the aging process and the modulus, tensile strength, and toughness increase with increasing aging time for all PVA molecular weights. The increased aging time allows more polymer chains to undergo conformation and spatial rearrangement, which leads to crystallite growth that strengthens the hydrogel. Table 6 lists mechanical properties of 10 wt % open cell PVA in 60 wt % DMSO.

TABLE 6
Mechanical properties of 10 wt % open-cell PVA in 60 wt % DMSO

| | | DMSO to water | | Liquid |
|---|---|---|---|---|
| Chain length | PVA Concentration | ratio | Aging time | component |
| Various | Fixed, 10 wt % | Fixed, 60 wt % | Various | DMSO/H₂O as |
| | | DMSO | | made, no salt |

| | | Tensile Modulus (kPa) | | | Tensile Strength (MPa) | | | Toughness (MJ/m³) | | |
|---|---|---|---|---|---|---|---|---|---|---|
| | | | Mw | | | Mw | | | Mw | |
| Aging | | Mw 31k- | 89k- | | Mw 31k- | 89k- | | Mw 31k- | 89k- | |
| Time | | 50k | 98k | Mw 195k | 50k | 98k | Mw 195k | 50k | 98k | Mw195k |
| 0 | day | 36.7 | 117 | 90.0 | 0.00967 | 0.493 | 0.90 | 0.0113 | 1.51 | 3.15 |
| 1 | day | 66.7 | 233 | 223 | 0.0132 | 0.800 | 2.05 | 0.00667 | 2.48 | 10.3 |
| 3 | days | 60.0 | 313 | 373 | 0.0135 | 1.02 | 2.62 | 0.00583 | 2.91 | 11.8 |
| 7 | days | 86.7 | 367 | 467 | 0.0160 | 1.06 | 3.22 | 0.00373 | 3.68 | 14.6 |

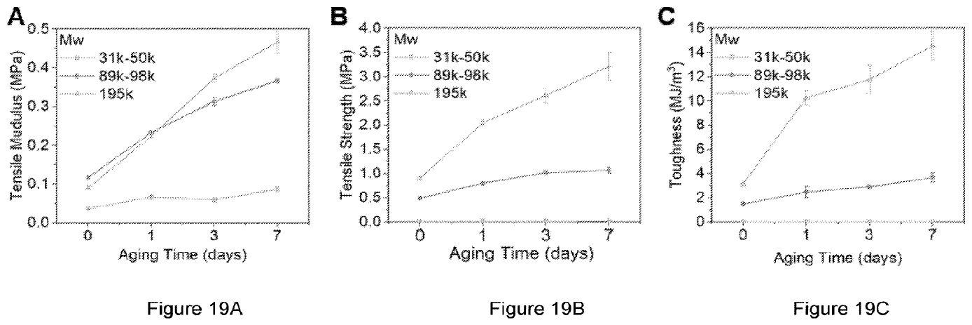

FIGS. 19A-19C illustrate tensile test results of 10% wt PVA hydrogels made with various molecular weights and 6:4 DMSO to water ratios with 0-7 days of aging in accordance with an embodiment. FIG. 19A shows the tensile modulus. FIG. 19B shows the tensile strength. FIG. 19C shows the toughness. Error bars represent standard deviations from 3-4 independent measurements.

The strength can be further improved by utilizing PVA solutions of higher concentrations. 15 wt % PVA solutions with molecular weight of about 195 k are used since higher concentrations can result in highly viscous solutions which are difficult to process. Similar to the 10 wt % PVA, the 15 wt % PVA also became stronger with aging, demonstrating the generality of aging. In summary, a 6:4 ratio, higher molecular weight, higher polymer concentration, and longer aging time produce stronger hydrogel. Table 7 lists mechanical properties of 15 wt % molecular weight 195 k open cell PVA in 60 wt % DMSO.

TABLE 7
Mechanical properties of 15 wt % Mw 195k open-cell PVA in 60 wt % DMSO

| Chain length | PVA Concentration | DMSO to water ratio | Aging time | Liquid component |
|---|---|---|---|---|
| Fixed, Mw 195k | Fixed, 15 wt % | Fixed, 60 wt % | Various | DMSO/H₂O as |
| | | DMSO | | made, no salt |

| Aging Time | | Tensile Modulus (MPa) | Tensile Strength (MPa) | Toughness (MJ/m³) |
|---|---|---|---|---|
| 0 | day | 0.270 | 1.67 | 5.12 |
| 1 | day | 0.680 | 2.40 | 8.60 |
| 3 | days | 1.23 | 4.35 | 19.3 |
| 7 | days | 1.30 | 4.60 | 21.2 |

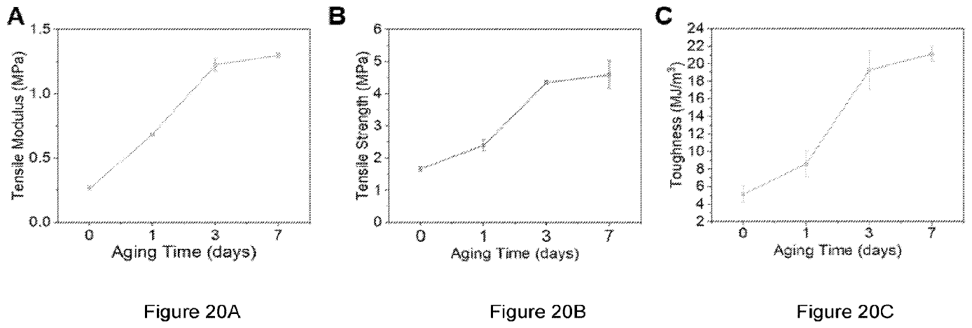

FIGS. 20A-20C illustrate tensile test results of 15% wt Mw 195 k PVA hydrogels made with various molecular weights and 6:4 DMSO to water ratios with 0-7 days of aging in accordance with an embodiment. FIG. 20A shows the tensile modulus. FIG. 20B shows the tensile strength. FIG. 20C shows the toughness. Error bars represent standard deviations from 3-4 independent measurements.

The synergistic effect of Hofmeister “salting-out” and cononsolvency produces better electrolytes than either of them alone. When comparing a cononsolvency-“salting-out” hydrogel with the cononsolvency-only hydrogel, the former shows improved mechanical robustness (at least 6 times higher modulus, 4 times higher tensile strength), demonstrating that Hofmeister “salting-out” treatment can effectively enhance the strength of the cononsolvency-only hydrogel, possibly via the growth of the crystalline domains generated from cononsolvency. Furthermore, Hofmeister “salting-out” also endows the hydrogel with ions that are needed for electrolytes. The cononsolvency hydrogel has a “diffusion friendly” open-cell porous structure, allowing for a homogeneous “salting-out” process to produce a hydrogel with a uniform structure and a smooth surface. By contrast, PVA formed by the regular freeze-thaw process has a semi-close-cell structure that hinders diffusion. Hofmeister “salting-out” these PVA can lead to a wrinkled or curled surface, which may be caused by the local strains generated from the inhomogeneous “salting-out” effect due to the slow diffusion of the ions. The non-smooth surface along with the diffusion-hindering microstructure renders such hydrogels not suitable for battery electrolytes, because of the high overpotential and large voltage polarization. By contrast, the cononsolvency-“salting-out” hydrogel shows 10 times smaller overpotential in the Zn—Zn cell test (0.23 V vs. 2.5 V at −20° C. with 0.5 mA cm⁻² current and 0.1 mA h cm⁻² capacity), originated from the open-cell structure. Furthermore, the small pores (~100 nm) are believed to frustrate the growth of micrometer-sized dendrites.

Apart from the improved mechanical and transport properties, PVA-416 also exhibits anti-freezing performance benefitted from the salt selection. To demonstrate this, hydrogels infiltrated with various types of liquids (ZnSO₄, sodium citrate, and the 416 solution, and water) are stretched at about 25° C. and −30° C. While similar strength can be achieved by other salts at 25° C. through Hofmeister “salting-out”, at −30° C., only the 416solution-containing PVA can be considered as “stretchable” rather than “brittle”, which benefits from the anti-freezing capability of the salt solution. In summary, the synergistic effect of cononsolvency and Hofmeister “salting-out” using the anti-freezing salt solutions provides a viable route to simultaneously enhance the strength, mass transport, and low-temperature tolerance of the hydrogel electrolytes. Table 8 lists mechanical properties of 15 wt % Mw 195 k PVA.

TABLE 8
Mechanical properties of 15 wt % Mw 195k PVA

| | | | | | | Ultimate | | |
|---|---|---|---|---|---|---|---|---|
| | | | DMSO | | | tensile | | Young's |
| | | PVA | to water | Aging | Liquid | strength | Toughness | modulus |
| Name | Chain length | Concentration | ratio | time | component | (MPa) | (MJ/m³) | (MPa) |
| 1 | Mw 195k | 15 wt % | 0 (semi- | No | 416 solution | 6.50 | 36.0 | 1.40 |
| | | | close | Aging | | | | |
| | | | cell) | | | | | |
| 2 | | | 60 wt % | No | DMSO/H₂O as | 1.67 | 5.12 | 0.27 |
| | | | | Aging | made, no salt | | | |
| 3 | | | 60 wt % | 7 days | DMSO/H₂O as | 4.60 | 21.2 | 1.30 |
| | | | | | made, No salt | | | |
| 4 | | | 60 wt % | 7 days | Pure H₂O, no | 0.51 | 1.43 | 0.05 |
| | | | | | salt | | | |
| PVA-416 | | | 60 wt % | 7 days | 416 solution | 15.6 | 82.0 | 7.33 |

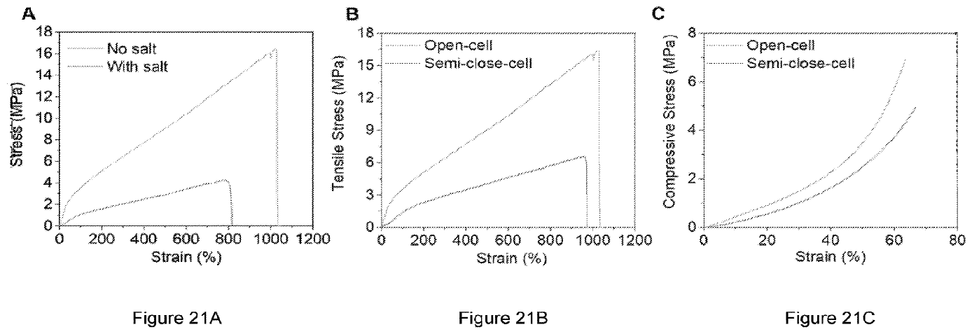

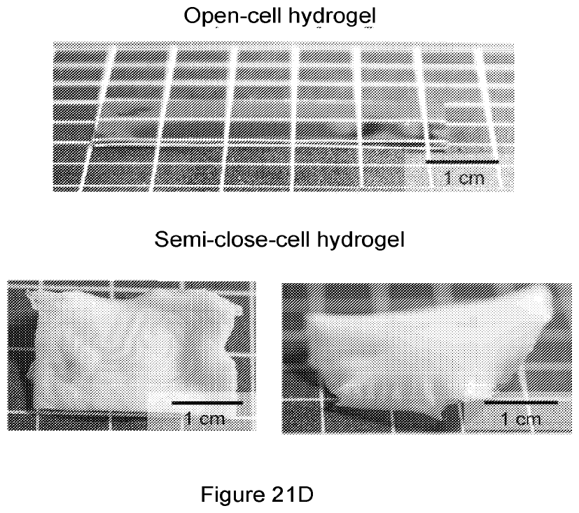

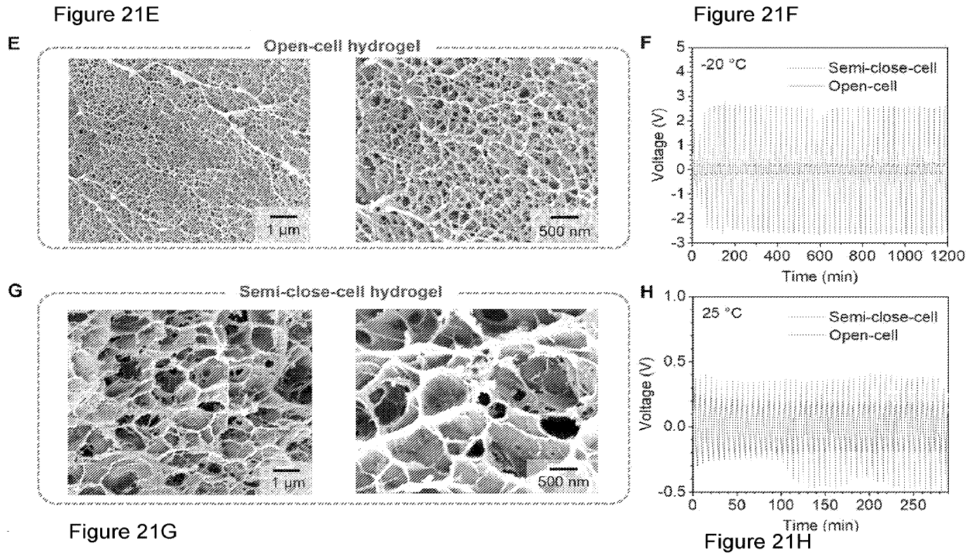

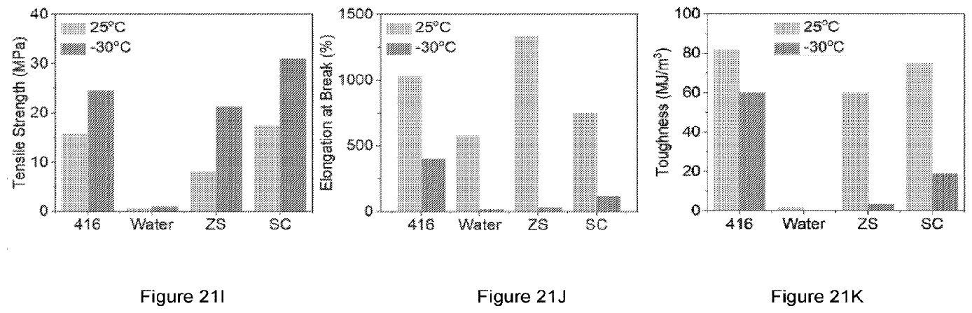

FIGS. 21A-21K illustrate synergistic effect of Hofmeister “salting-out” and cononsolvency in accordance with an embodiment. FIG. 21A shows a stress-strain curve of the cononsolvency-“salting-out” hydrogel and the cononsolvency-only hydrogel. FIGS. 21B and 21C show tensile and compression tests of the cononsolvency-“salting-out” hydrogel and the “salting-out”-only hydrogel respectively. FIG. 21D shows photographs of the open-cell hydrogels (from cononsolvency) showing the smooth and flat surfaces, and semi-close-cell hydrogels (no cononsolvency) showing the wrinkled and curved surfaces. FIGS. 21E and 21G show SEM images of the open-cell and semi-close-cell hydrogels respectively. FIGS. 21F and 21H show the voltage profiles of Zn—Zn symmetric cell made with open-cell and semi-close-cell hydrogel electrolytes at −20° C. and 25° C., respectively. FIGS. 21I-21K show tensile test results of the hydrogels with different solutions at 25° C. and −30° C., where ZS is zinc sulfate and SC is sodium citrate.

The cononsolvency-“salting-out” hydrogel (PVA-416) is used for further characterization, since it shows good mechanical, thermal, and mass transport properties and is organic solvent-free. NMR spectra of the PVA-416 and the control sample (1 wt % DMSO in water) show that the residual DMSO in the hydrogel electrolyte is much less than 1 wt % and too low to be detected. PVA-416 shows adequate transference number (0.517) and ionic conductivity (49.8 mS/cm at 25° C.) to be used as a battery electrolyte. While the freezing temperature is inconclusive from the DSC measurement which possibly results from the complex water-ion-polymer interactions, the hydrogel still remains mechanically flexible after being held at −77° C. for 24 hours, demonstrating its anti-freezing property. Mechanically, PVA-416 shows a much higher strength and toughness than the wetted glass fiber separators commonly used in zinc-ion batteries, in the tensile, compression, and puncture force tests, demonstrating improved mechanical robustness. The 15.6 MPa tensile strength of the hydrogel (wet material) is higher than that of the wearable electronics wristbands (dry solid material, 11.6 MPa on average). In the calendar aging tests, the PVA-416-containing cell shows higher efficiency than the cell with the glass fiber separators. The high strength of the hydrogel may retard dendritic growth, which effectively prevents the formation of dead Zn and improves efficiency.

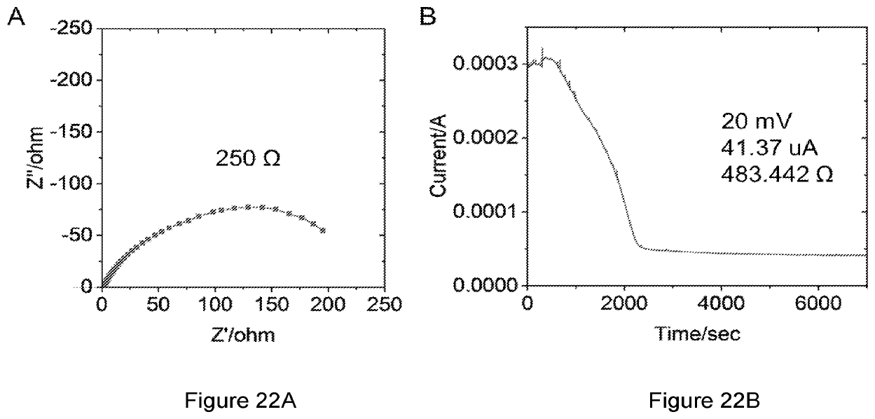

FIGS. 22A and 22B illustrate transference number characterization of PVA-416 in accordance with an embodiment. FIG. 22A shows EIS before polarization. FIG. 22B shows steady-state current.

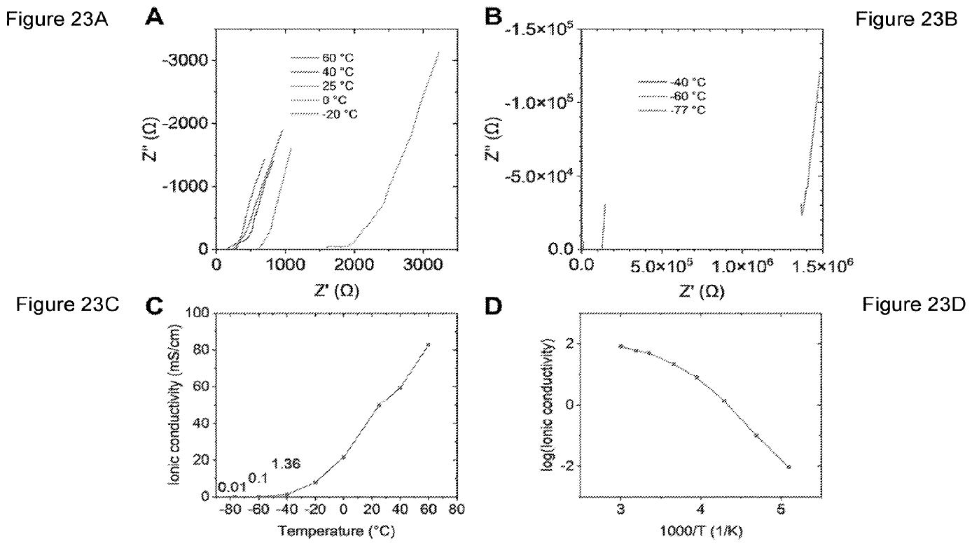

FIGS. 23A-23D illustrate ionic conductivity measurements of the PVA-416 hydrogel electrolyte at various temperatures in accordance with an embodiment. FIGS. 23A and 23B show Nyquist plots of the impedance measurements at different temperatures. FIG. 23C shows ionic conductivities at various temperatures. FIG. 23D shows Arrhenius plot of ionic conductivity.

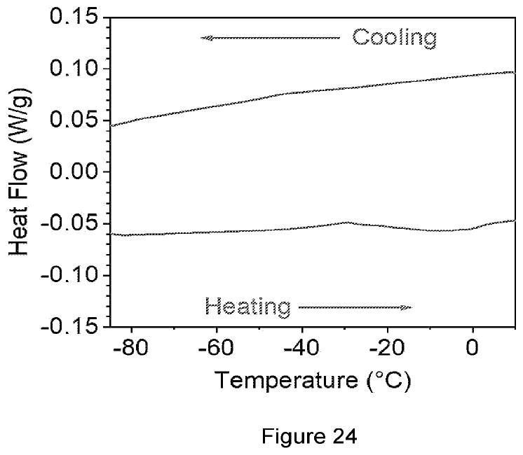

FIG. 24 illustrates DSC curves of the PVA-416 hydrogel electrolyte in accordance with an embodiment.

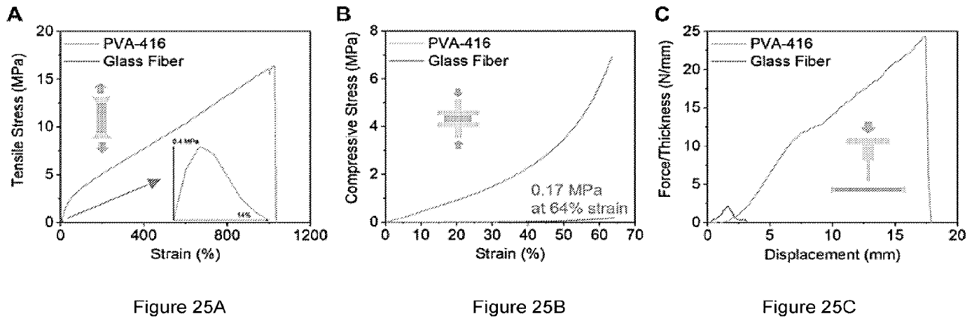

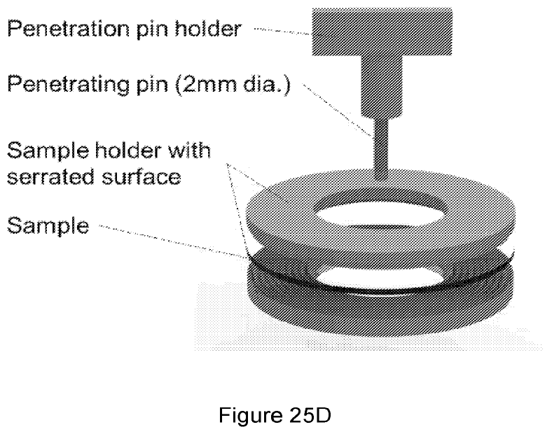

FIGS. 25A-25C illustrate results from the tensile tests, compression tests, and puncture force tests of the PVA-416 electrolyte and the glass fiber separator wetted with the 416 solution at 25° C. in accordance with an embodiment. The insets are schematics of the mechanical tests. FIG. 25D illustrates a schematic of a puncture test setup in accordance with an embodiment.

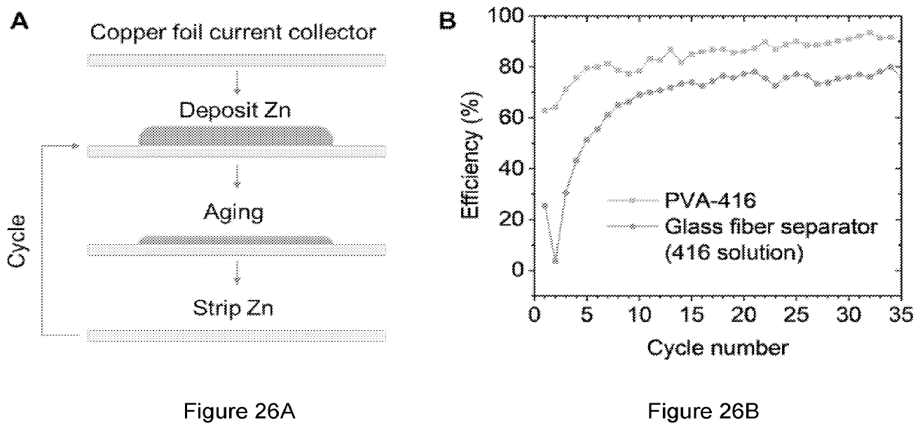

FIGS. 26A and 26B illustrate calendar aging tests in accordance with an embodiment. FIG. 26A shows a schematic of the testing steps. FIG. 26B shows the efficiency of the cells using different electrolytes. Efficiency=stripped capacity (mAh)/deposited capacity (mAh).

The 100 μm thick PVA-416s are used to make coin cell batteries to test their electrochemical performances at various temperatures (25, −20, −30, −40, and −45° C.) with Zn foil anodes and polyaniline (PANi). Cyclic voltammetry (CV) displayed the reversible peaks at 1.3 V and 1.05 V vs. Zn/Zn²⁺, corresponding to the ion storage in the positively or negatively charged nitrogen sites in the oxidized or reduced PANi, respectively. The rate performances at about 0.1, 0.2, 0.5, 1, and 5 A g⁻¹ are about 96, 88, 76, 68, and 46 mA h g⁻¹ respectively at 25° C., and about 89, 82, 71, 59, and 18 mA h g⁻¹ respectively at −20° C. When the temperature further drops to about −30° C., capacities are about 92, 80, 56, 34, and 8 mA h g⁻¹ at current densities of about 0.1, 0.2, 0.5, 1, and 2 A g⁻¹, respectively. For all temperatures, the final low-current cycles show similar capacities as the initial low-current cycles, implying that the decrease in capacity at higher currents can be mainly attributed to the ion transport kinetics rather than the structural degradation of the electrode or the electrolyte. The voltage window of the charging-discharging plateau matches that of the redox peaks from the CV. The cycling performances are also evaluated at various temperatures. At about 2 A g⁻¹, the battery provides a reversible capacity of about 52.2 and 57.5 mA h g⁻¹ after 1,000 cycles at 25° C. and 30,000 cycles at −20° C., respectively, with an imperceptible decrease in capacity at −20° C., showing its ultrahigh stability. The decrease in capacity at 25° C. may be attributed to the deprotonation and swelling/shrinking of PANi, which might be alleviated at low temperatures, leading to higher stability. When tested at −30° C., the battery displays a reversible capacity of about 57.5 mA h g⁻¹ after 1,000 cycles at 0.5 A g⁻¹, with a small 5% capacity fading compared to the 10^{th} cycle. The batteries can function at about −40 and −45° C., benefitted from the high anti-freezing performance of the hydrogel. Overall, the battery's high stability and temperature tolerance are enabled by the anti-freezing, dendrite retarding, and reversible zinc chemistry-enabling hydrogel electrolyte.

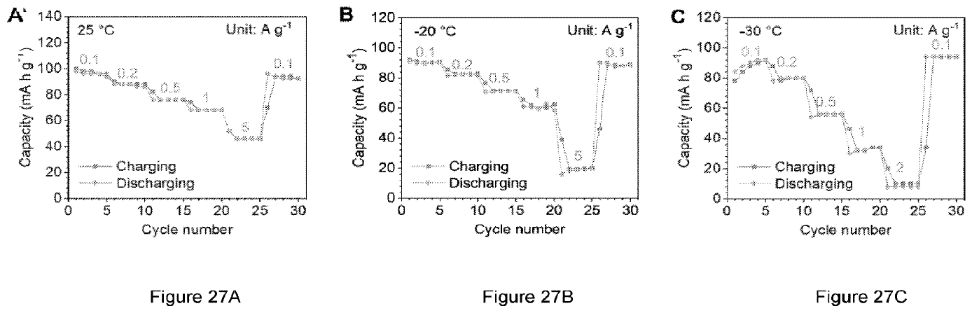

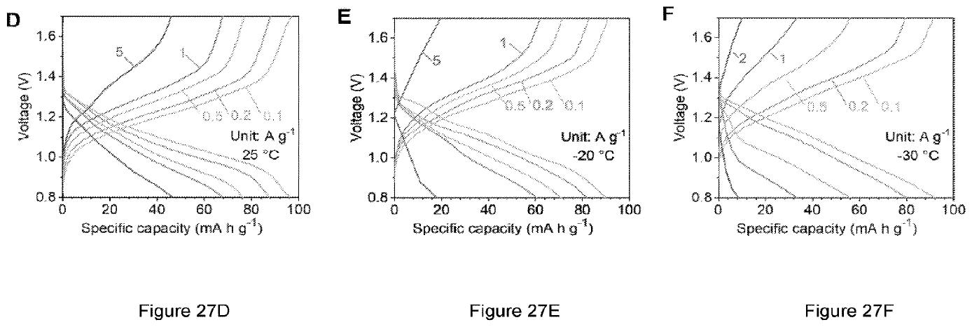

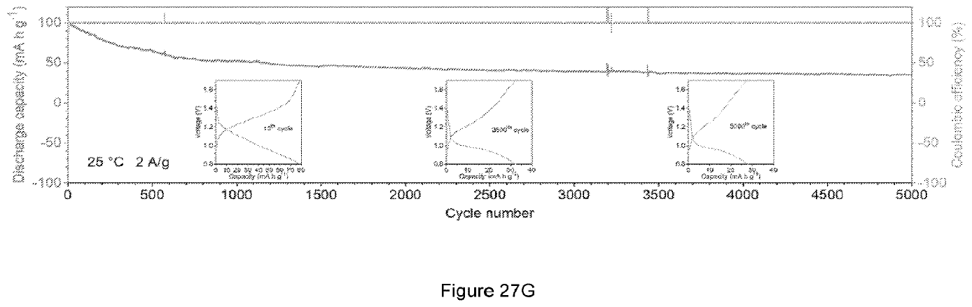

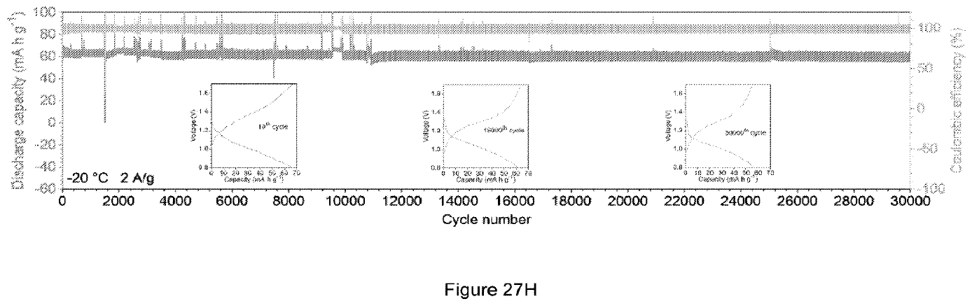

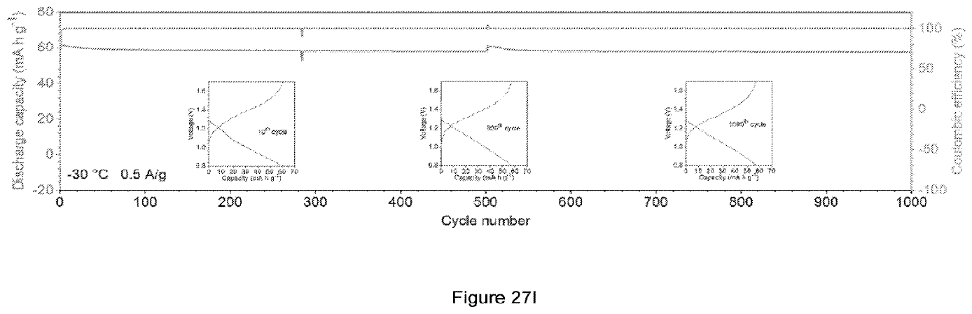

FIGS. 27A-27I illustrate electrochemical performance of the Zn-PVA-416-PANi batteries at about 25, −20, and −30° C. in accordance with an embodiment. FIGS. 27A-27C show rate performance of the batteries. FIGS. 27D-27F show Galvanic charge-discharge curves of the batteries. FIGS. 27G-27I show cycling performance of the batteries. Insets are the galvanic charge-discharge curves at different cycles.

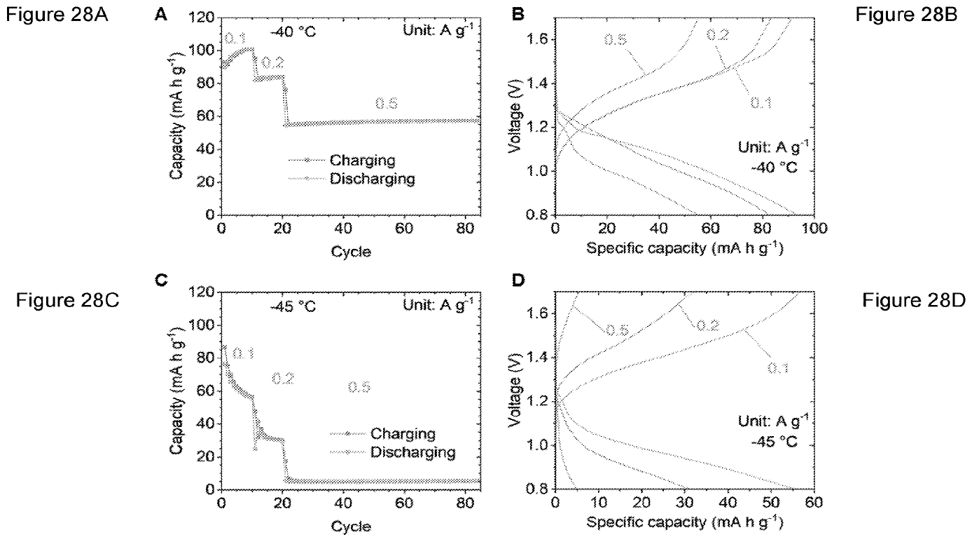

FIGS. 28A-28D illustrate electrochemical performance of the Zn-PVA-416-PANi batteries at −40 and −45° C. in accordance with an embodiment. FIGS. 28A and 28C show rate performance of the batteries. FIGS. 28B and 28D show Galvanic charge-discharge curves of the batteries.

To further demonstrate the dendrite suppression capability and reversible zinc chemistry, the Zn anodes are analyzed after the Zn-PANi batteries are cycled 100 times (48 hours), with glass fiber separator/416 solution or PVA-416 as the electrolytes. While both electrolytes achieve dendrite-free (by scanning electron microscopy) and reversible Zn chemistry (by X-ray powder diffraction), the zinc deposition is less uniform when the glass fiber separator is used, and some zinc deposits into the glass fiber matrix, which makes the batteries prone to shorting. The enhanced uniformity can be a result of the high hydrogel strength, which benefits the battery stability.

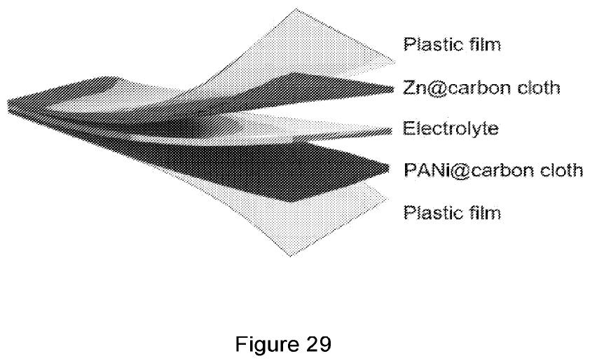

To demonstrate the impact resistance and anti-freezing capability at the device level, low-temperature hammer tests are conducted on the soft pack batteries. FIG. 29 illustrates a schematic of the soft-pack battery in accordance with an embodiment. During the hammer test, a metal rod (196 g) is used to connect a “hammerhead” (164 g) with a free-rotating axis fixed on the table to construct the “hammer”. During the impact events, the “hammerhead” is lifted to 16 cm above the batteries. The PVA-416 battery is able to withstand at least 8 times of impact compared to the one with glass fiber separators (estimated energy and force per impact event are 1,952 J m⁻² and 130 N, respectively). The soft-pack battery with PVA-416 electrolyte can also withstand being repeatedly run over by a car weighing 1,750 kg. The PVA-416 hydrogel electrolyte can have tensile strength of about 16 MPa; toughness of about 84 MJ m⁻³; Young's modulus of about 8 MPa; freezing temperature of about −80° C.; ionic conductivity (at room temperature) of about 50 mS/cm. The hydrogel electrolyte can support stable low-temperature operation for over 30,000 cycles, and with better impact resistivity and zinc deposition uniformity compared to the conventional glass fiber separator.

The cononsolvency-“salting-out” method is also applicable to other material combinations to produce strong, anti-freezing, and mass-transport-friendly electrolytes. In some embodiments, the 416 solution can be combined with hydrogels such as open-cell porous poly(N-isopropylacrylamide) (PNIPAAm) and poly(N-tertbutylacrylamide-co-acrylamide) (P(NTBAAm-co-AAm)) hydrogels to increase their temperature tolerance and toughness. The Zn-PNIPAAm-PANi battery could cycle at 0.1 A g⁻ at −20° C. (about 55.4 mA h g⁻¹ capacity at the 100^{th} cycle), demonstrating the anti-freezing property of the electrolyte. In certain embodiments, the open-cell porous PVA hydrogel can be combined with a 446 solution (the mass ratio of KAc/ZnAc₂·2H₂O/H₂O is 4/4/6) to make PVA-446 hydrogel electrolyte. The new electrolyte combined with a revised operation voltage window can achieve a more stable Zn-PANi battery at 25° C., possibly because of the lower pH of the 446 solution compared to that of the 416 solution (7.26 and 8.37, respectively) that can decrease the deprotonation speed of PANi. The PVA-446 electrolyte is also functional in freezing temperatures, where the battery operates over 3,000 cycles at −20° C.

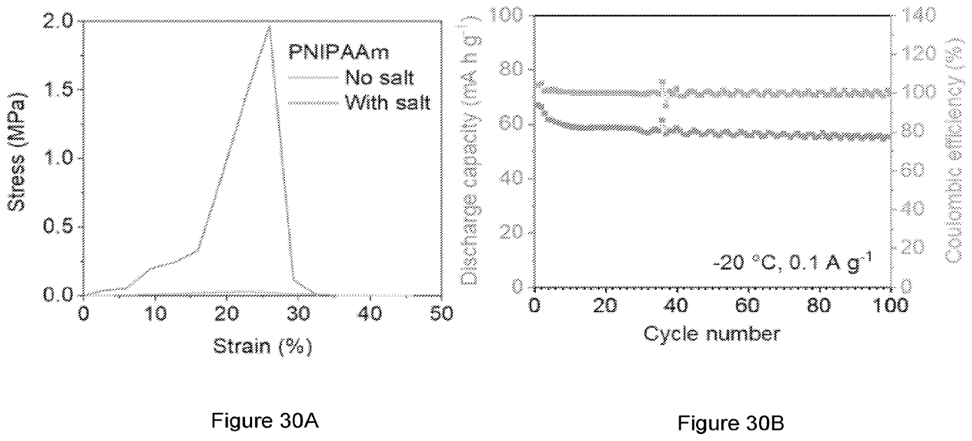

FIGS. 30A-30B illustrate characterizations of the PNIPAAm hydrogels in accordance with an embodiment. FIG. 30A shows stress-strain curves of the PNIPAAm hydrogels with or without salt. FIG. 30B shows cycle performance of the Zn-PANi battery at −20° C. with a PNIPAAm hydrogel as the electrolyte.

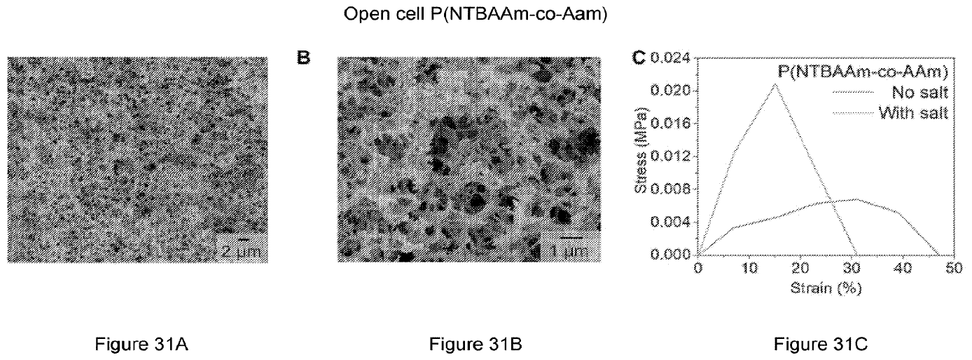

FIGS. 31A-31C illustrate characterizations of the P(NTBAAm-co-AAm) hydrogels in accordance with an embodiment. FIGS. 31A and 31B show SEM images of the open-cell P(NTBAAm-co-AAm) hydrogels. FIG. 31C shows stress-strain curves of the P(NTBAAm-co-AAm) hydrogels with or without salt.

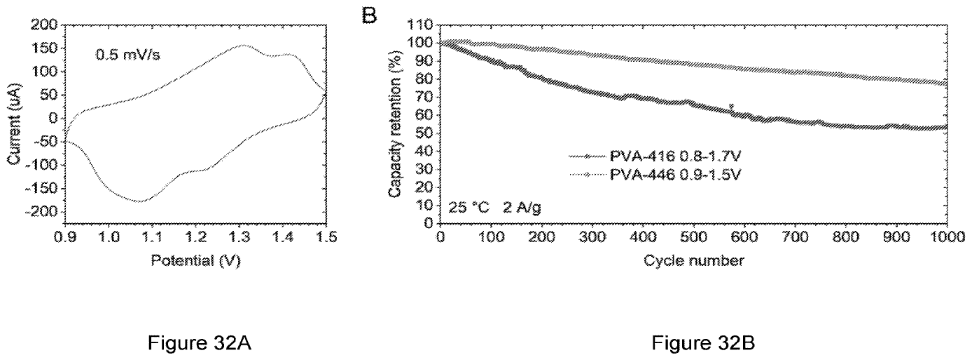

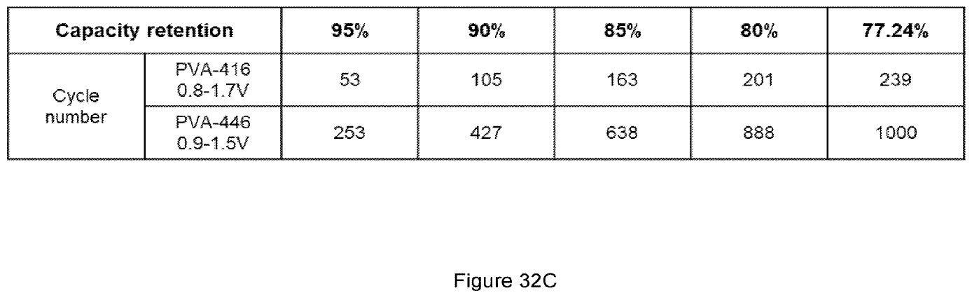

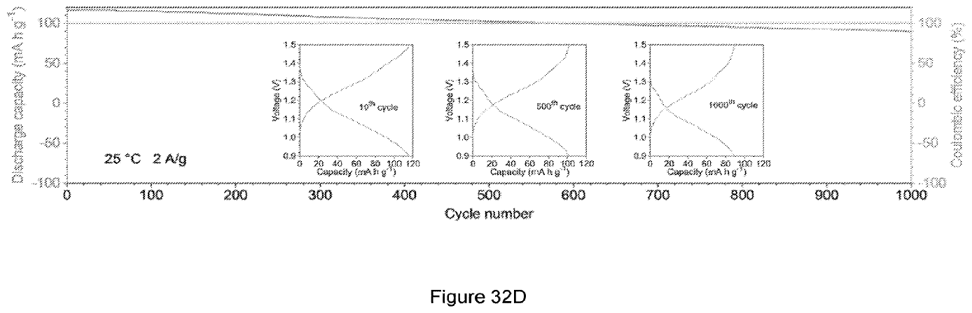

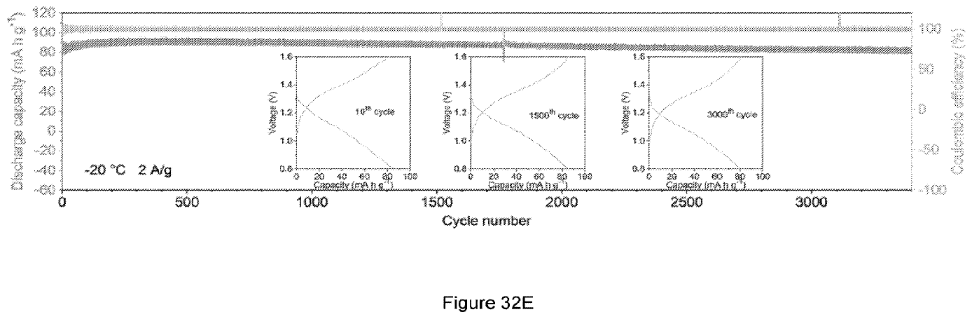

FIGS. 32A-32E illustrate electrochemical characterization of the Zn-PVA-446-PANi batteries in accordance with an embodiment. FIG. 32A shows cyclic voltammogram of the Zn-PVA-446-PANi battery at 25° C. FIGS. 32B and 32C show comparison of the capacity retention. Same cathodes (PANi) and anodes (Zn foil) are used for both. The new result displayed four to five times higher stability compared to that of the old result according to C). FIGS. 32D and 32E show cycling performance of the Zn-PVA-446-PANi batteries. Insets are the galvanic charge-discharge curves at different cycles.

### EXEMPLARY EMBODIMENTS

Although specific embodiments of compositions, methods and process are discussed in the following sections it will be understood that these embodiments are provided as exemplary and are not intended to be limiting.

### Example 1: Materials and Methods

Materials. Zinc sulfate heptahydrate (99%), poly(vinyl alcohol) (weight-average molecular weight (Mw) of 89-98 kDa and 195 kDa; degree of hydrolysis of 99%), zinc perchlorate hexahydrate, zinc chloride (reagent grade, ≥98%), aniline (≥99.5%), ammonium persulfate (≥98%) are used. Dimethyl sulfoxide (>99.7%), hydrochloric acid (36% technical), ELAT carbon cloth, and commercial glass fiber are used. Poly(vinyl alcohol) Mw 31,000-50,000, Mw 89,000-98,000, Mowiol 56-98, potassium acetate (≥99.0%), zinc acetate dihydrate, ammonium persulfate, poly(ethylene glycol) diacrylate (PEGDA, average Mn 700), aniline, N-tert-butylacrylamide (NTBAAm, 97%), N,N′-methylenebis(acrylamide) (MBAA, 99%), sodium sulfate, boric acid, zinc sulfate heptahydrate, sodium citrate tribasic dihydrate, zinc perchlorate hexahydrate, potassium citrate tribasic monohydrate (99-100.5%), sodium carbonate (≥99.0%), sodium acetate (≥99.0%), and zinc chloride (≥98%) are used. Dimethyl Sulfoxide (DMSO) (D128), hydrochloric acid (A144), and hexanes (HPLC Grade, H302) are used. Acrylamide (AAm, 98.5%) and N-isopropylacrylamide (NIPAAm, 99%, stabilized) are used. 2-hydroxy-2-methylpropiophenone (>96.0%) and zinc(II) trifluoromethanesulfonate (>98.0%) are used. Zinc bis(trifluoromethylsulfonyl)imide is used. Zinc nitrate hexahydrate (min. 98%) is used. Deuterium oxide with DSS is used. Copper foil (9 um), coin cell case, spacer (15.8 mm*1.5 mm), and funnel spring (15.4 mm*1.1 mm) are used. Zinc foil (0.07 mm) is used. Commercial glass fiber separators are used. ELAT hydrophilic plain carbon cloth is used. Prior to use, the carbon cloth is subjected to 20 min oxygen plasma treatment with a PDC-001 plasma cleaner.

Preparation of PVA precursors. PVA precursor solutions are prepared by adding 10 wt % of PVA powder in water or DMSO. Then the mixtures are heated up to 95° C. and stirred for 2 hours to form colorless transparent solutions.

Fabrication of electrolyte hydrogels. The PVA/H₂O solution is mixed with the PVA/DMSO solution at a 2:3 weight ratio. After thoroughly mixing and degassing by a centrifuge, the clear solution is poured into molds and put in a freezer (−20° C.) for 2 hours to complete gelation. The as formed hydrogels are soaked into DMSO/H₂O/ZnSO₄ solutions for 96 h.

Fabrication of 0 wt % and 100 wt % DMSO PVA hydrogels. The PVA/H₂O solution and PVA/DMSO solution are first degassed by centrifuge, then poured into molds and put in a freezer (−20° C.) for 2 hours. They are then soaked in DMSO/H₂O/ZnSO₄ solutions for 96 h.

Preparation of DMSO/H₂O/ZnSO₄ solutions. DMSO, water, and ZnSO₄-7H₂O salt are added according to the weight ratios in Table 1 and are stirred until transparent colorless solutions were formed.

Preparation of the PANi Cathode. 0.365 mL aniline monomer is added into 15 mL 1 M HCl solution with continuous stirring and then carbon cloth pieces (3×3 cm, oxygen plasma treated) are dipped into the solution and stored in the refrigerator at 4° C. for 1 h. 5 mL 1 M HCl solution containing 0.228 g ammonium persulfate (APS) is prepared and stored in the refrigerator for 1 h. The two solutions are then mixed and placed at room temperature for 3 h. Then, the products are washed with deionized water and ethanol, then dried at 60° C. overnight. The mass loading of PANi is about 0.5 mg cm⁻² measured by a scale (0.1 mg). The PANi/carbon cloth pieces are then cut into 1 cm-by-1 cm pieces for use.

Fabrication of the Zn@carbon cloth anodes. The Zn@carbon cloth electrodes are used instead of the zinc foils to assemble the soft-pack batteries to enhance the flexibility. The Zn is electrodeposited on a carbon cloth using a sourcemeter with a −40 mA cm⁻² current density for 10 min in a freshly-prepared electrolyte made of 12.5 g zinc sulfate heptahydrate, 12.5 g sodium sulfate, 2 g boric acid, and 100 g water. A carbon cloth of the same size is used as the counter electrode. After the deposition, the product is washed with water and dried in ambient overnight. The product has a silver color. The mass loadings are ~10 mg cm⁻² measured by an electronic scale. To fully utilize the Zn deposited on the 3D structure, the anodes are gently wetted with the 416 solution before use.

Fabrication of the PVA hydrogels. To fabricate the open-cell porous PVA hydrogels, PVA solutions with 100% water and 100% DMSO as the solvent are prepared by adding PVA and the solvent into a sealed glass jar to the desired weight percentage (10%, 15%, or 20%), and the mixtures are heated to 95° C. in a water bath and are stirred at 200 rpm for up to 4 h to yield transparent and homogeneous solutions. Then, the PVA aqueous solution and the PVA DMSO solution are mixed in a centrifuge tube to the desired weight ratio (3:7, 4:6, 5:5, 6:4, 7:3, 8:2) and centrifuged at 3,000 rpm for 90 s to remove the bubbles. Finally, the mixture is transferred into glass molds, and the entire assembly is put in a −20° C. freezer overnight to form the hydrogel. Then, the hydrogel is taken out of the mold and is put in a sealed container at room temperature for different durations (0, 1, 3, or 7 days), then is immersed in the 416 solution for 3 days, during which the solution is exchanged for at least 5 times to ensure the complete substitution of the liquid component in the hydrogels.

It is the best practice to do the mixing, degassing, and transferring as fast as possible to keep the solution hot during these processes since the gelation can be fast (especially for the ones with a 6:4 water to DMSO ratio and high PVA concentrations), and the hydrogel may not be in the desired shape if the gelation happens before the mixture is transferred into the glass mold.

To fabricate the semi-close-cell PVA, Mw 195 k PVA and water are added into a sealed glass jar to the desired weight percentage (15%), and the mixture is heated to 95° C. with a water bath and was stirred at 200 rpm for up to 4 h to yield a transparent and homogeneous solution. Then, the PVA aqueous solution is transferred into a centrifuge tube and then centrifuged at 3,000 rpm for 90 s to remove the bubbles. Finally, the degassed solution is transferred into a glass mold, and the entire assembly is put in a −20° C. freezer overnight to freeze the solution. The frozen solution is then taken out of the mold and is directly immersed in the 416 solution for 3 days, during which the solution is exchanged at least 5 times.

The open-cell hydrogel used to compare with the semi-close-cell hydrogel is Mw 195 k PVA, 15 wt %, 6:4 DMSO to water ratio, aged for 7 days and then soaked in the 416 solution.

The recipes used to compare different liquids in the hydrogel: Hydrogels are Mw 195 k PVA, 15 wt %, 6:4 DMSO to water ratio, aged for 7 days. Then, they are soaked in water, or the 416 solution, or a zinc sulfate solution (mass ratio of zinc sulfate heptahydrate to water was 0.575 to 1), or a sodium citrate solution (mass ratio of sodium citrate tribasic dihydrate to water was 0.441 to 1) for 3 days. During the soaking, the salt solutions and water are exchanged at least 5 times.

Fabrication of the PNIPAAm and the P(NTBAAm-co-AAm) hydrogels. To make the PNIPAAm precursor, the NIPAAm monomers are first purified by dissolving 50 g of NIPAAm in 600 mL hexane at 60° C. After dissolution, the solution is put in an ice bath, and the monomers (precipitation) are filtered out. Then, 1150 mg of the purified monomers, 95 mg PEGDA, and 5 μL Darocur 1173 are mixed with a 1 mL mixture of DMSO/H₂O (DMSO to H₂O ratio=4:6 v/v).

To make the P(NTBAAm-co-AAm) precursor, 200 mg NTBAAm, 100 mg AAm, 150 mg MBAA, 25 μL of Darocur 1173, 3.5 g DMSO, and 1.5 g H₂O are mixed.

To fabricate the hydrogels, the precursor solutions are injected into glass molds and received 20 s of UV irradiation. The resulting PNIPAAm hydrogel is then completely dialyzed in DI water and freeze-dried (liquid nitrogen for freezing, freeze-dryer for drying), then soaked in DI water to fabricate the PNIPAAm with no salt, or soaked in the 416 solution to fabricate the PNIPAAm with salt. The P(NTBAAm-co-AAm) hydrogel from the UV polymerization is then soaked in DI water to fabricate the hydrogel with no salt, or soaked in the 416 solution to fabricate the hydrogel with salt.

Tensile testing. Hydrogels are cut into 2 mm wide strips for tensile testing. The thickness of each sample is measured with a caliper. For the low temperature tensile testing, samples are stored in freezer (−20° C.) for 2 hours, then quickly took out to do the tensile test. The data are obtained using a mechanical tester with a 50 N loading cell installed. Tensile moduli are obtained by calculating the slope of the stress-strain curves, tensile strengths are determined by the highest point on the stress-strain curves, and toughness is calculated by integrating the areas under the stress-strain curves. Error bars represent standard deviations from 3-4 independent measurements.

For the puncture test, the pin holder and sample holders (outer diameter 4 cm, inner diameter 2 cm) are 3D printed using polylactic acid. A stainless-steel rod (2 mm diameter) is used as the penetrating pin. The sample holders are held together with paper clips. During puncture tests, the pin starts moving down from the position of the samples' top surface until breakage occurred. The puncture forces are divided by the sample thicknesses and plotted against the displacement distances of the pin.

For low-temperature tensile tests, a temperature probe is attached to the sample clamp. The samples and clamps are placed in a glass cylinder, which is used to hold the dry ice. The samples and clamps are then immersed under dry ice cobbles until the temperature readout is below −30° C., where neither the sample nor the temperature probe is in direct contact with the dry ice. Then the tensile tests are immediately started. The temperature readouts during the tests are in the range of −25 to −33° C.

Compression testing. Hydrogels are cut into 2 mm-by-2 mm square piece for compression testing. The thickness of each sample is measured with a caliper. For the low temperature compression testing, samples are stored in freezer (−20° C.) for 2 hours, then quickly took out to do the compression test. The data are obtained using a mechanical tester with a 50 N loading cell installed.

SEM characterizations. All hydrogel samples are immersed and thoroughly washed in pure water for 24 h to remove the salts. Then the samples are frozen in liquid nitrogen and freeze-dried using a freeze drier. To characterize dendrite growth, the Zn anodes are taken out from the battery and washed with water. The freeze-dried hydrogels and Zn anodes are observed using a SEM.

Hydrogel samples are cut into small pieces (~5 mm length) and dialyzed in DI water for at least 7 days to completely get rid of the salt ions or DMSO that are in the hydrogel, during which the water is exchanged at least 5 times. Then the hydrogels are rapidly immersed in liquid nitrogen (rather than floating on it, to ensure minimal ice templating which could disrupt the original morphology of the hydrogel) until no bubble is coming from the sample. The samples are then broken into smaller pieces by being hit with a steel rod while immersed in liquid nitrogen. The samples are then freeze-dried with a freeze-dryer operating at 0.022 mbar for 48 h. The SEM is conducted using a 9 kV accelerating voltage. The fracture surfaces generated by the steel rod hitting are used to record the SEM images since the pores on the other surfaces might have collapsed during the freezing process.

XRD characterization. The Zn anodes are taken out from the battery and washed with water. XRD is recorded with a Cu Kα radiation source. Prior to the experiment, the zinc anodes are gently washed with DI water, then dried at 50° C. to remove the residual salts on them.

DSC characterization. A DSC-Q8000 is used to record the DSC result with a cooling rate of 5° C./min.

Raman spectroscopy characterization. Raman spectroscopy are conducted with a Raman microscope with 633 nm laser wavelength. The equipment is calibrated with a silicon standard before use. Data are collected with 10 s exposure time, 50% laser power, and 5 accumulations. Data are normalized in such a way that the intensity of all samples at 3,230 cm⁻ wavenumbers to be the same.

Coin cell testing. The coin cells are assembled with a hydraulic crimping machine with 1,000 psi pressure and are tested with a battery tester. The −20° C. environment is created using a freezer, and the temperature is double-checked with a thermometer whose probe is attached to the coin cell shell. The temperature in the freezer has periodical fluctuation, which can influence the coin cell output. The −30, −40, and −45° C. environments are created using a cooling bath with ethanol. The coin cells are put in Ziploc bags and immersed in ethanol, and the temperatures are double-checked with the thermometer.

To compare KAc/ZnAc₂ solutions of different concentrations, Zn∥Cu half cells are assembled with copper foils, zinc foils, and glass fiber separators, which are cut into 20 mm, 14 mm, and 20 mm diameter disks, respectively. 100 μL of the electrolytes are added to each coin cell during the assembly.

To compare the open-cell and close-cell hydrogels, Zn∥Zn symmetric cells are made with zinc foils and hydrogel electrolytes, which are cut into 10 mm and 20 mm diameter disks, respectively. 0.5 mA cm⁻², 0.1 mA h cm⁻², 50 cycles are used to test the cells at −20° C., and 2 mA cm⁻², 0.1 mA h cm⁻², 50 cycles are used to test the cells at 25° C.

To compare the calendar aging performance of the hydrogel and the liquid electrolyte, Zn∥Cu half cells are assembled with copper foils, zinc foils, and PVA-416 hydrogels (or glass fiber separators), which are cut into 20 mm, 14 mm, and 20 mm diameter disks, respectively. 100 μL of the 416 solution is added to the glass fiber separator. The activation process is done by depositing Zn on Cu and then stripping immediately (to 0.7 V, with the same current density), which consisted of six cycles: 0.195 mA cm⁻² for 10 min (3 cycles) followed by 0.5 mA cm⁻² for 30 min (3 cycles). The aging performance is tested by first depositing Zn at 0.5 mA cm⁻² current for 30 min, then resting (open circuit) the cell for 5 h, and stripping Zn using the same current density to 0.7 V. The efficiencies were calculated as

$$Efficiency = \frac{Stripped capacity ( mAh )}{Deposited capacity ( mAh )}$$

To test the Zn∥hydrogel∥PANi cells, zinc foils and hydrogel electrolytes are cut into 14 mm and 20 mm diameter disks, and the carbon cloths with PANi were cut into pieces (1 cm² area). For the cycle tests at 25° C., the coin cell is activated using 0.1, 0.2, 0.5, and 1 A/g currents (one cycle for each). For the cycle tests at −20° C. and −30° C., the coin cell was activated using a 0.1 A/g current for one cycle.

Ionic conductivity. Ionic conductivities are tested with a CHI660e electrochemical workstation using electrochemical impedance spectroscopy mode. Carbon clothes are used as the electrodes. The two electrodes are parallelly fixed on the same side of a glass slide with double-sided tapes with 2.128 cm distance in between. A hydrogel membrane with 1.882 cm width and 0.089 cm thickness is put on top of the electrodes, and another piece of glass slide is put on top of the hydrogel membrane. Binder clips are used to clamp the two glass slides which ensure a good contact between the hydrogel and the electrode. The bulk resistances are used to calculate the ionic conductivity, which can be estimated as the high-frequency intercept of the Nyquist plots with the real axis. Based on the testing geometry, the area in the formula is hydrogel thickness multiplied by width:

$$Ionic conductivity ( mS / cm ) = \frac{1 , 000 ⋆ Distance between the electrodes ( cm )}{Bulk resistance ( Ω ) * hydrogel thickness * width ( {cm}^{2} )}$$

The temperature control is done by sealing the setup in Ziploc bags and immersing it in an ethanol cooling bath or put the setup on top of a hot plate. The temperatures are double-checked with a thermometer.

Transference number. Zn∥Zn symmetric coin cells are assembled using a PVA-416 hydrogel electrolyte, and electrochemical impedance spectroscopy and current-time measurements are conducted. The transference number is calculated as

$$t = \frac{{R}_{cell}}{{R}_{DC}} = \frac{{R}_{c e l l} {I}_{D C}}{0.02 V}$$

where R_{cell} is resistance before polarization and I_{DC} is the steady state current.

Cyclic voltammetry. The data are collected with a CHI660e electrochemical workstation, and the coin cells are connected to the machine via a coin cell clamp.

Differential scanning calorimetry. DSC Q2000 Calorimeter with an RC-90 cooling system is used to record the DSC data. The samples are initially equilibrated at 15° C., then cooled to −90° C. at a 2° C. min⁻¹ rate. Then the samples are held at −90° C. for 30 min and heated to 15° C. at a 2° C. min⁻¹ rate. Empty pans are used as the reference sample. The sample loadings are −25 mg. Because liquid has a large tendency to over-cool, the melting temperatures measured from the heating process are regarded as the solid-liquid transition temperatures for the liquid samples.

Testing the freezing temperature of the PVA-416 hydrogel. The PVA-416 is put in a Ziploc bag and immersed in the cooled ethanol for 24 hours. The temperatures are double-checked with the thermometer.

Soft-pack batteries. PANi@carbon cloth and Zn@carbon cloth electrodes are used to make the soft-pack batteries. The carbon cloth electrodes were connected to the wires (B-30-1000, VT corporation) with copper tapes (3M 1181), and the electrode/copper tape/wire assemblies are fixed on the plastic sheets (Scotch self-seal laminating pouches) via the Devcon 5-minute epoxy. The hydrogels (500 μm thick) are then sandwiched between the two electrode/plastic sheet assemblies. The plastic sheets (as the enclosure of the batteries) are cut to the desired sizes and pressed together to seal. Scotch super 33+ tapes are then used to seal the edges of the plastic sheets. The batteries with glass fiber separators are made with two layers of glass fiber, with a total thickness of 520 μm. The soft-pack batteries are used in the hammer test and the run-over test. In these tests, two batteries were connected in series to provide enough voltage to lit the LED.

Hammer test. A home-built hammer test setup is employed in pursuit of achieving repeatable impact forces in every impact event. An AP180 mounting plate (Thorlabs) is used as the joint that allows rotation with minimal resistance. The “hammer” consisted of a metal rod and a compatible mounting plate as the “hammerhead”. In each of the impact events, the “hammerhead” is lifted to 16 cm above the batteries. The batteries and blocks of ice were equilibrated in a −20° C. freezer before the tests. The tests are done in ambient conditions. During the test, the batteries are put on a block of ice to de-escalate the increase in temperature. Infrared videos are recorded using a thermal imager. A high-speed camera is utilized to record the duration of the impact events at 3,000 fps (data not shown). The impact energy and force are calculated from the height (16 cm), the weight of the hammerhead and the rod (164 g and 196 g, respectively), contact area (3 cm by 7 mm), rod length (26 cm), and duration of the impact ( 1/300 s). The energy is calculated by

$$\frac{( 0.1 \; 64 kg \times 0.16 m + 0.196 kg \times \frac{0.16 m}{2} ) \times 9.8 \frac{m}{{s}^{2}}}{0.03 m \times 0.007 m} = \frac{0.41 J}{2.1 \times 1 {0}^{- 4} {m}^{2}} = 1952 ( J {m}^{- 2} )$$

Force is calculated by

$$Force ( N ) \times \frac{1}{300} s \times 0.26 m = Radial velocity ( rad {s}^{- 2} ) \times Rotational Inertia ( kg {m}^{2} )$$

where

$$Rotational Inertia = \frac{0.196 kg \times {( 0.26 m )}^{2}}{3} + 0.1 \; 64 kg \times {( 0.26 m )}^{2} = 0.0 \; 155 kg {m}^{2}$$

$$and$$

$$\frac{0.0155 ( kg {m}^{2} ) \times {( Radial velocity )}^{2}}{2} = 0.41 J .$$

### Example 2: Electrolytes

Background: Conventional hydrogels typically exhibit slow diffusion and poor mechanical properties due to the homogeneously closed pore structure. Current approaches to enhancing the diffusion and mechanical toughness involve tuning the pore size, via changing the crosslinking density and monomer concentration; however, these current strategies cannot increase the diffusion rate and toughness at the same time, i.e., increasing one property at the cost of undermining the other or unsatisfactorily improving the other. Current methods to produce hierarchical structures include templating, adding macro/nano materials, and layer-by-layer. However, current strategies suffer from drawbacks like complex procedures, expensive raw materials, waste generation due to sacrificial templates, small-scale fabrication, and non-tunable structures.

These issues are addressed by the method according to disclosure. This method decouples the contradictory design principles of high mechanical and diffusive properties via ion-solvent-polymer ternary interactions, by modulating multiple length scale interactions, nano-, micron- and millimeter-level interactions of molecules (including monomer/polymer and maybe nanomaterial additives) through introducing ions and solvent mixtures in monomers or polymers sequentially or concurrently.

Liquid Electrolytes: these are typically composed of organic solvents such as dimethyl carbonate or ethylene carbonate with dissolved salts such as lithium hexafluorophosphate and lithium bis(trifluoromethanesulfonyl)imide. These systems restrict the anode of the battery cell to graphite or other carbon-based anodes due to their intrinsic flammability and potential for thermal runaway; the ideal cell utilizes metal anodes that can have up to 10× higher theoretical capacity, but these metal anodes suffer from high reactivity with liquid electrolytes, resulting in fast capacity fade, accelerated dendrite growth, and high risk of thermal runaway. Careful encapsulation requirements must be considered to avoid leaking liquid electrolyte into the environment, where air and moisture induces breakdown into toxic and corrosive byproducts such as hydrofluoric acid vapor.

Other Solid Electrolytes: most typical solid electrolytes currently being investigated and employed include pure polymers, sulfides, oxides, and composites. Common polymer electrolytes suffer from low ionic conductivity, electrochemical instability, and side reactions with Li-metal. Sulfides suffer from extreme thermodynamic instability and are unusable at high C-rates and low temperatures. Oxides are unsuccessful in suppressing dendrites due to their brittleness. Most state-of-the-art composites are unstable and do not suppress dendrites, which grow through the polymer ceramic interface. In contrast, our approach incorporates additives, pore structure engineering, and molecular weight tuning to improve both conductivity and stability.

### Example 2A: Gel Polymer Electrolyte

Mechanism: After implementing the typical procedure disclosed above according to embodiments, one obtains tough cross-linked polymer networks with highly interconnected pore structure. Then, the solvents in the polymer matrix can be exchanged with liquid electrolytes, creating gel polymer electrolytes whereby the liquid component is encapsulated within the polymer matrix.

Application Scenarios: mainstream lithium-ion batteries utilize electrolytes composed of organic solvents with dissolved lithium salts. Such liquid electrolyte systems suffer from accelerated dendrite growth, solvent leakage, and low cycle life. Gel Polymer electrolytes can be used as a replacement to liquid electrolytes to resolve these limitations.

### Example 2B: Solid Polymer Electrolyte

Mechanism: A tough cross-linked polymer with highly interconnected pore structure, synthesized using the methods described above according to embodiments, can be endowed with high ionic conductivity without the use of solvents by one of two ways: 1) selection of ionically conductive polymers for the framework, containing donor electron functional groups, or 2) swelling with freely mobile ionically conductive linear polymer such as polyethylene oxide.

Application Scenarios: elimination of organic solvents in current lithium-ion batteries for improved fire resistance and safety. Enabling ultra-robust soft batteries from the excellent flexibility, stretchability, and durability of the electrolyte material.

Competitive advantage: 1) Improved fire resistance, 2) Improved metal anode compatibility, and 3) Improved battery durability.

### Example 2C: Polymer-Ceramic Composite Electrolyte

Mechanism: The tough cross-linked polymer networks with highly interconnected pores described above according to embodiments can be converted into polymer-ceramic composite electrolytes by two ways: 1) incorporation of ionically conductive ceramic particles followed by swelling with ionically conducting polymers and salts, or 2) sintering the polymer framework with embedded precursors to create a ceramic framework, followed by swelling with ionically conducting polymers and salts.

Application Scenarios: enabling lithium metal anodes for higher energy density batteries.

Competitive advantage: 1) Improved fire resistance, 2) Improved metal anode compatibility, 3) Higher ionic conductivities, 4) Improved dendrite resistance, and 5) Wider electrochemical stability.

### Example 2D: Templated Super-Porous Carbon Matrix

Mechanism: tough cross-linked polymer networks with highly interconnected pores described above according to embodiments can be converted into super-porous carbon scaffolds via carbonization at high temperatures, the high mechanical properties serving to preserve the structure during this process.

Application Scenarios: battery anodes with higher surface area and improved charging performance.

Competitive Advantage: 1) controlled porosity and tortuosity for performance optimization, 2) High specific surface area, 3) High ionic conductivities, and 4) Reduced anode-electrolyte interfacial resistance.

### Example 2E: Porous Filtration Membrane

Mechanism: tough cross-linked polymer networks with highly interconnected pores described above according to embodiments can be converted into porous polymer membrane with the solvent removed via e.g. lyophilization or super critical CO₂ drying. Thermal gradient, concentration gradient, etc, can be utilized which enables gradient pore structure in a monolith to avoid blocking the small pores too quickly.

Application Scenarios: filtration membrane with controlled selectivity and excellent durability due to controlled porosity and enhanced mechanical property, respectively.

Competitive Advantage: 1) controlled selectivity, and 2) excellent durability.

### EXAMPLES

Example 1: A method of fabricating a hydrogel comprising: mixing a solute, a solvent, and a cosolvent to form a hydrogel via a cononsolvency effect, wherein the solute dissolves in the solvent and the cosolvent, wherein the solvent and the cosolvent are miscible and have different polarity; and solidifying the hydrogel in a salt solution, wherein the salt solution induces a formation of a plurality of hydrogen bonds in the hydrogel such that the hydrogel toughens.

Example 2: The method of example 1, wherein the cosolvent has a stronger interaction with the solute than the solvent.

Example 3: The method of example 1 or 2, further comprising heating and stirring the mixed solute, solvent, and cosolvent to form a homogeneous solution before forming a hydrogel.

Example 4: The method of example 1, or 2, or 3, further comprising forming the hydrogel in a mold to achieve a desired shape.

Example 5: The method of any one of examples 1 to 4, wherein the hydrogel is formed in a freezer.

Example 6: The method of any one of examples 1 to 5, wherein the solute is a polymer selected from the group consisting of poly(n-isopropyl acrylamide) (PNIPAM), poly(vinyl alcohol) (PVA), polyacrylamide (PAM), and poly(N-tert-butyl acrylamide)-co-polyacrylamide (PNTBAM-co-PAM).

Example 7: The method of any one of examples 1 to 6, wherein the solute is PVA, the solvent is dimethyl sulfoxide (DMSO), the cosolvent is water, and the salt solution comprises zinc sulfate.

Example 8: The method of any one of examples 1 to 7, wherein the toughened hydrogel has a tensile strength of at least 1.5 MPa, a toughness of at least 4.5 MJ/m³, and an ionic conductivity of at least 4.7 mS/cm at −20° C.

Example 9: The method of any one of examples 1 to 8, wherein the toughened hydrogel is anti-freezing at a temperature lower than or equal to −20° C. and is configured to be a portion of a zinc ion battery.

Example 10: The method of any one of examples 1 to 9, wherein the zinc ion battery is a zinc polyaniline battery, and the battery is dendrite-free after at least 3000 cycles from 25° C. to −20° C.

Example 11: The method of any one of examples 1 to 10, wherein the solute is selected from the group consisting of PNIPAM, PVA and PNTBAM-co-PAM, the solvent is DMSO, the cosolvent is water, and the salt solution comprises potassium acetate and zinc acetate.

Example 12: The method of any one of examples 1 to 11, wherein the toughened hydrogel has a tensile strength of at least 15 MPa, a toughness of at least 84 MJ/m³, a Young's modulus of at least 8 MPa, and an ionic conductivity of at least 50 mS/cm at 20° C.

Example 13: The method of any one of examples 1 to 12, wherein the toughened hydrogel is anti-freezing at a temperature lower than or equal to −80° C. and is configured to be a portion of a zinc ion battery.

Example 14: The method of any one of examples 1 to 13, wherein the zinc ion battery is a zinc polyaniline battery, the battery is dendrite-free after at least 30,000 cycles from 25° C. to −20° C., and the battery has a reversible capacity of 50 mA h g⁻¹ after 1,000 cycles at 25° C., and a reversible capacity of 57 mA h g⁻¹ after 30,000 cycles at −20° C.

Example 15: A method of fabricating a zinc ion battery comprising: forming a cathode and an anode for a zinc ion battery; and forming a hydrogel electrolyte positioned in between the cathode and the anode, wherein the hydrogel electrolyte is formed via a process comprising: mixing a solute, a solvent, and a cosolvent to form a hydrogel via a cononsolvency effect, wherein the solute dissolves in the solvent and the cosolvent, wherein the solvent and the cosolvent are miscible and have different polarity; and solidifying the hydrogel in a salt solution, wherein the salt solution induces a formation of a plurality of hydrogen bonds in the hydrogel such that the hydrogel toughens.

Example 16: The method of example 15, wherein the cosolvent has a stronger interaction with the solute than the solvent.

Example 17: The method of example 15 or 16, further comprising heating and stirring the mixed solute, solvent, and cosolvent to form a homogeneous solution before forming a hydrogel.

Example 18: The method of example 15, or 16, or 17, further comprising forming the hydrogel in a mold to achieve a desired shape.

Example 19: The method of any one of examples 15 to 18, wherein the hydrogel is formed in a freezer.

Example 20: The method of any one of examples 15 to 19, wherein the solute is a polymer selected from the group consisting of poly(n-isopropyl acrylamide) (PNIPAM), poly(vinyl alcohol) (PVA), polyacrylamide (PAM), and poly(N-tert-butyl acrylamide)-co-polyacrylamide (PNTBAM-co-PAM).

Example 21: The method of any one of examples 15 to 20, wherein the solute is PVA, the solvent is dimethyl sulfoxide (DMSO), the cosolvent is water, and the salt solution comprises zinc sulfate.

Example 22: The method of any one of examples 15 to 21, wherein the toughened hydrogel has a tensile strength of at least 1.5 MPa, a toughness of at least 4.5 MJ/m³, and an ionic conductivity of at least 4.7 mS/cm at −20° C.

Example 23: The method of any one of examples 15 to 22, wherein the toughened hydrogel is anti-freezing at a temperature lower than or equal to −20° C.

Example 24: The method of any one of examples 15 to 23, wherein the battery is a zinc polyaniline battery, and the battery is dendrite-free after at least 3000 cycles from 25° C. to −20° C.

Example 25: The method of any one of examples 15 to 24, wherein the solute is selected from the group consisting of PNIPAM, PVA and PNTBAM-co-PAM, the solvent is DMSO, the cosolvent is water, and the salt solution comprises potassium acetate and zinc acetate.

Example 2θ: The method of any one of examples 15 to 25, wherein the toughened hydrogel has a tensile strength of at least 15 MPa, a toughness of at least 84 MJ/m³, a Young's modulus of at least 8 MPa, and an ionic conductivity of at least 50 mS/cm at 20° C.

Example 27: The method of any one of examples 15 to 2θ, wherein the toughened hydrogel is anti-freezing at a temperature lower than or equal to −80° C.

Example 28: The method of any one of examples 15 to 27, wherein the battery is a zinc polyaniline battery, and the battery is dendrite-free after at least 30,000 cycles from 25° C. to −20° C., and the battery has a reversible capacity of 50 mA h g⁻¹ after 1,000 cycles at 25° C., and a reversible capacity of 57 mA h g⁻¹ after 30,000 cycles at −20° C.

### DOCTRINE OF EQUIVALENTS

As can be inferred from the above discussion, the above-mentioned concepts can be implemented in a variety of arrangements in accordance with embodiments of the invention. Accordingly, although the present invention has been described in certain specific aspects, many additional modifications and variations would be apparent to those skilled in the art. It is therefore to be understood that the present invention may be practiced otherwise than specifically described. Thus, embodiments of the present invention should be considered in all respects as illustrative and not restrictive.

As used herein, the singular terms “a,” “an,” and “the” may include plural referents unless the context clearly dictates otherwise. Reference to an object in the singular is not intended to mean “one and only one” unless explicitly so stated, but rather “one or more.”

As used herein, the terms “approximately,” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to +2%, less than or equal to ±1%, less than or equal to ±0.5%, less than or equal to ±0.1%, or less than or equal to ±0.05%.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

What is claimed is:

1. A method of fabricating a hydrogel comprising:
mixing a solute, a solvent, and a cosolvent to form a hydrogel via a cononsolvency effect, wherein the solute dissolves in the solvent and the cosolvent, wherein the solvent and the cosolvent are miscible and have different polarity; and
solidifying the hydrogel in a salt solution, wherein the salt solution induces a formation of a plurality of hydrogen bonds in the hydrogel such that the hydrogel toughens.

2. The method of claim 1, wherein the cosolvent has a stronger interaction with the solute than the solvent.

3. The method of claim 1, further comprising heating and stirring the mixed solute, solvent, and cosolvent to form a homogeneous solution before forming a hydrogel.

4. The method of claim 1, further comprising forming the hydrogel in a mold to achieve a desired shape.

5. The method of claim 1, wherein the hydrogel is formed in a freezer.

6. The method of claim 1, wherein the solute is a polymer selected from the group consisting of poly(n-isopropyl acrylamide) (PNIPAM), poly(vinyl alcohol) (PVA), polyacrylamide (PAM), and poly(N-tert-butyl acrylamide)-co-polyacrylamide (PNTBAM-co-PAM).

7. The method of claim 1, wherein the solute is PVA, the solvent is dimethyl sulfoxide (DMSO), the cosolvent is water, and the salt solution comprises zinc sulfate.

8. The method of claim 7, wherein the toughened hydrogel has a tensile strength of at least 1.5 MPa, a toughness of at least 4.5 MJ/m³, and an ionic conductivity of at least 4.7 mS/cm at −20° C.

9. The method of claim 7, wherein the toughened hydrogel is anti-freezing at a temperature lower than or equal to −20° C. and is configured to be a portion of a zinc ion battery.

10. The method of claim 9, wherein the zinc ion battery is a zinc polyaniline battery, and the battery is dendrite-free after at least 3000 cycles from 25° C. to −20° C.

11. The method of claim 1, wherein the solute is selected from the group consisting of PNIPAM, PVA and PNTBAM-co-PAM, the solvent is DMSO, the cosolvent is water, and the salt solution comprises potassium acetate and zinc acetate.

12. The method of claim 11, wherein the toughened hydrogel has a tensile strength of at least 15 MPa, a toughness of at least 84 MJ/m³, a Young's modulus of at least 8 MPa, and an ionic conductivity of at least 50 mS/cm at 20° C.

13. The method of claim 11, wherein the toughened hydrogel is anti-freezing at a temperature lower than or equal to −80° C. and is configured to be a portion of a zinc ion battery.

14. The method of claim 13, wherein the zinc ion battery is a zinc polyaniline battery, the battery is dendrite-free after at least 30,000 cycles from 25° C. to −20° C., and the battery has a reversible capacity of 50 mA h g⁻¹ after 1,000 cycles at 25° C., and a reversible capacity of 57 mA h g⁻¹ after 30,000 cycles at −20° C.

15. A method of fabricating a zinc ion battery comprising:
forming a cathode and an anode for a zinc ion battery, and
forming a hydrogel electrolyte positioned in between the cathode and the anode, wherein the hydrogel electrolyte is formed via a process comprising:
mixing a solute, a solvent, and a cosolvent to form a hydrogel via a cononsolvency effect, wherein the solute dissolves in the solvent and the cosolvent, wherein the solvent and the cosolvent are miscible and have different polarity; and
solidifying the hydrogel in a salt solution, wherein the salt solution induces a formation of a plurality of hydrogen bonds in the hydrogel such that the hydrogel toughens.

16. The method of claim 15, wherein the cosolvent has a stronger interaction with the solute than the solvent.

17. The method of claim 15, further comprising heating and stirring the mixed solute, solvent, and cosolvent to form a homogeneous solution before forming a hydrogel.

18. The method of claim 15, further comprising forming the hydrogel in a mold to achieve a desired shape.

19. The method of claim 15, wherein the hydrogel is formed in a freezer.

20. The method of claim 15, wherein the solute is a polymer selected from the group consisting of poly(n-isopropyl acrylamide) (PNIPAM), poly(vinyl alcohol) (PVA), polyacrylamide (PAM), and poly(N-tert-butyl acrylamide)-co-polyacrylamide (PNTBAM-co-PAM).

21. The method of claim 15, wherein the solute is PVA, the solvent is dimethyl sulfoxide (DMSO), the cosolvent is water, and the salt solution comprises zinc sulfate.

22. The method of claim 21, wherein the toughened hydrogel has a tensile strength of at least 1.5 MPa, a toughness of at least 4.5 MJ/m³, and an ionic conductivity of at least 4.7 mS/cm at −20° C.

23. The method of claim 21, wherein the toughened hydrogel is anti-freezing at a temperature lower than or equal to −20° C.

24. The method of claim 21, wherein the battery is a zinc polyaniline battery, and the battery is dendrite-free after at least 3000 cycles from 25° C. to −20° C.

25. The method of claim 15, wherein the solute is selected from the group consisting of PNIPAM, PVA and PNTBAM-co-PAM, the solvent is DMSO, the cosolvent is water, and the salt solution comprises potassium acetate and zinc acetate.

26. The method of claim 25, wherein the toughened hydrogel has a tensile strength of at least 15 MPa, a toughness of at least 84 MJ/m³, a Young's modulus of at least 8 MPa, and an ionic conductivity of at least 50 mS/cm at 20° C.

27. The method of claim 15, wherein the toughened hydrogel is anti-freezing at a temperature lower than or equal to −80° C.

28. The method of claim 15, wherein the battery is a zinc polyaniline battery, and the battery is dendrite-free after at least 30,000 cycles from 25° C. to −20° C., and the battery has a reversible capacity of 50 mA h g⁻¹ after 1,000 cycles at 25° C., and a reversible capacity of 57 mA h g⁻¹ after 30,000 cycles at −20° C.
